(19) United States
(12) Patent Application Publication
(10) Pub. No.: US 2006/0089865 A1
(43) Pub. Date: Apr. 27, 2006

(54) Computer-aided method for managing a part shipping apparatus development project

(75) Inventors: Kenneth A. Mazur, Rochester Hills, MI (US); David M. Hicken, Rochester Hills, MI (US); Joyce E. Kindermann, Leonard, MI (US); Stephanie M. Warren, Utica, MI (US)

Correspondence Address: BROOKS KUSHMAN P.C., 1000 TOWN CENTER, TWENTY-SECOND FLOOR, SOUTHFIELD, MI, 48075, US

(73) Assignee: McNulty Hicken Smith, Inc., Rochester Hills, MI (US)

(21) Appl. No.: 10/972,863

(22) Filed: Oct. 25, 2004

(51) Int. Cl. G06F 9/46

(52) U.S. Cl. 705/8

(57) ABSTRACT

A computer-aided method for managing a part shipping apparatus development project including a plurality of predetermined processes or procedures is provided. The method includes receiving information about the part and storing a first set of data which identifies the part in at least one database. The method further includes filling out a first electronic work initiation request form including a plurality of fields and stored in the at least one database wherein one of the fields specifies work to be performed with respect to apparatus for shipping the part. A second set of data is stored which identifies the apparatus in the at least one database. Production materials are created which allow the building of production apparatus for shipping the part based on the second set of data.

### BACKGROUND OF THE INVENTION

1. Field of the Invention

The present invention relates to computer-aided methods of managing development projects and, in particular, to computer-aided methods for managing a part shipping apparatus development project.

2. Background Art

The shipping and assembly of a multi-component product, such as an automobile, typically involves the simultaneous activities of many business groups. For example, one group may be responsible for the powertrain components of a vehicle, another group for the electrical system, another group for the body structure, another for the interior, another for the exterior, another group for the chassis, etc.

Apparatus for shipping such components or parts to one or more locations for assembly may include dunnage as well as containers such as racks.

The design and engineering of such apparatus can often be as complex as the components or parts which are containerized by the containers. The ability to timely communicate among the designers and engineers of the containers, the suppliers of the parts, any pre-production container builders and the assembler is very important, especially when changes are made to the parts or containers during the container development project.

U.S. Pat. No. 5,761,063 discloses a design and engineering project management system comprising a computer including a microprocessor, program memory, data storage memory, one or more displays, logic for identifying overall product objectives and group objectives relating to each of one or more subsystems or components of the overall product and displaying the overall objective and group objectives in a plurality of graphic windows which are quickly retrieved by the system operator, thereby integrating the diverse interests and activities of the groups into a comprehensive system design and implementation program. The system also preferably includes logic for identifying one or more strategies for achieving group objectives and presenting the strategies in a graphic form which allows for quick comparison of competing strategies. The system also preferably includes logic for quantitatively measuring progress toward each group's stated objectives and providing a plurality of graphic displays indicating each group's, and the entire project's toward its objectives.

U.S. Pat. No. 4,875,162 to Ferriter et al. discloses a method for interfacing a project management tool with a conceptual design tool used for building and modifying the structure of a product such as a lawnmower. In operation, the project management tool interface prompts a user to define various items concerning the product structure. This design data is put into a database and, a hierarchical tree of the structure is generated on a computer screen. The user may then access this information from manufacturing data gathered by the conceptual design tool. The data accessed is formatted in a file of the project management tool and then imported into the project management tool. This data can then be modified by the project management tool and can be reformatted for export to the conceptual design tool so as to allow the design process to continue with updated project data.

### SUMMARY OF THE INVENTION

An object of the present invention is to provide an improved computer-aided method of managing development projects and, in particular, to computer-aided methods for managing a part shipping apparatus development project.

In carrying out the above object and other objects of the present invention, a computer-aided method for managing a part shipping apparatus development project including a plurality of predetermined processes or procedures is provided. The method includes receiving information about the part and storing a first set of data which identifies the part in at least one database. The method further includes filling out a first electronic work initiation request form including a plurality of fields and stored in the at least one database wherein one of the fields specifies work to be performed with respect to apparatus for shipping the part. A second set of data is stored which identifies the apparatus in the at least one database. Production materials are created which allow the building of production apparatus for shipping the part based on the second set of data.

The project may include a build process or procedure, and the method may further include filling out an electronic release form stored in the at least one database to release a builder to perform at least one build function during the build process or procedure.

A first article container may be built during the build process or procedure, and the method may further include inspecting the first article container and recording results of the inspection.

The method may further include filling out a field order change form stored in the at least one database to identify, approve and implement a field order change to the apparatus.

The method may further include filling out a second electronic work initiation request form including a plurality of fields and stored in the at least one database wherein one of the fields specifies the field order change.

The work to be performed may be apparatus design work and the form may be a design form for requesting work to design the apparatus.

The work to be performed may be apparatus build work and the form may be a build form for requesting work to build the apparatus.

One of the fields of the form may specify a deviation from one of the predetermined processes or procedures.

One of the fields of the form may specify status of the form.

The at least one build function may include building a prototype of the apparatus and the method may further include reviewing the prototype and recording results of the review in the at least one database.

The step of receiving may include the step of receiving math data which represents the part.

The apparatus may include a rack.

A plurality of parts may be shipped and the second set of data may identify orientation of the parts in the rack.

The apparatus may include dunnage, a standard container, or an expendable container.

The method may further include modifying the second set of data to obtain a revised second set of data which identifies the apparatus, and the step of creating production materials may be based on the revised second set of data.

A plurality of parts may be shipped and the second set of data may identify density of the parts to be shipped with the apparatus.

The second set of data may identify a supplier to supply the apparatus.

The part may be a vehicle part.

The at least one data base may include a relational database.

The second set of data may also identify a transportation mode for the container and may identify part load and unload information with respect to the apparatus.

The project may include a container development process or procedure and the method may further include conducting at least one pre-concept phase activity and recording the results of the at least one pre-concept phase activity in the at least one database.

The project may include a rack development process or procedure and the method may further include conducting at least one concept phase activity and recording the results of the at least one concept phase activity in the at least one database.

The method may further include conducting at least one design for manufacture activity and recording the results of the at least one design for manufacture activity in the at least one database The method may further include conducting at least one prototype draw activity and recording the results of the at least one prototype draw activity in the at least one database.

The method may include monitoring the build process or procedure and collecting and recording information on any changes to be made to the apparatus during the build process or procedure in the at least one database.

The method may include filling out an electronic requisition form including a plurality of fields and stored in the at least one database to conduct purchasing activities.

The method may further include filling out an electronic shipping request form including a plurality of fields and stored in the at least one database to ship product or materials.

The project may include a rack development process or procedure and the method may further include conducting at least one density study activity and recording the results of the at least one density study activity in the at least one database.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a block diagram of a computer network-implemented system for carrying out many of the method steps of the present invention;

FIG. 2 is a block diagram flow chart of one embodiment of a project control process or method of the present invention;

FIG. 3 is a block diagram flow chart of a container/dunnage development process of the project control process;

FIG. 4 is a block diagram flow chart of a prototype build process of the project control process;

FIGS. 5a and 5b are block diagram flow charts of a procedure for testing packaging of the project control process;

FIGS. 6a and 6b are block diagram flow charts of a process to conduct initiate/manage build phase activities of the project control process;

FIG. 7 is a block diagram flow chart of a process to conduct final build print phase activities of the project control process;

FIG. 8 is a block diagram flow chart of a process for containerizing C/E/F items of the container development process;

FIG. 9 is a block diagram flow chart of a process to conduct pre-concept phase activities of the container development process;

FIG. 10 is a block diagram flow chart of a process for containerizing B-items of the container development process;

FIG. 11 is a block diagram flow chart of a process to conduct density study activities of the container development process;

FIG. 12 is a block diagram flow chart of a process to conduct concept phase activities of the container development process;

FIG. 13 is a checklist used at a meeting to obtain information about parts, containers, suppliers, transportation mode, load/unload instructions, etc. which information is used to populate at least one database of the present invention;

FIG. 14 is a block diagram flow chart of a process to conduct design-for-manufacturing (DFM) phase activities of the container development process;

FIG. 15 is a block diagram flow chart of a process to conduct prototype draw phase activities of the container development process;

FIGS. 16a, 16b and 16c are block diagram flow charts of a process for requesting/scheduling/tracking work initiation from a container design group and/or a container prototype source;

FIG. 17 is a block diagram flow chart of a process for acquiring math data which represents a part to be containerized;

FIGS. 18a and 18b are block diagram flow charts of a process for verifying the math data;

FIG. 19 is a block diagram flow chart of a process for design/in-house prototype build line-up;

FIGS. 20a and 20b are block diagram flow charts of a process for in-process inspection of designs;

FIG. 21 is a block diagram flow chart of a process to select and evaluate suppliers;

FIGS. 22a and 22b are block diagram flow charts of a process to conduct purchasing activities;

FIG. 23 is a block diagram flow chart of a process for releasing suppliers to perform build functions;

FIGS. 24a and 24b are block diagram flow charts of a process to package, load and ship product or materials via a commercial carrier;

FIG. 25 is a block diagram flow chart of a process to organize, store and protect product from the receiving process and to release and ship product;

FIGS. 26a and 26b are block diagram flow charts of a process to receive, inspect, identify and control product and material prior to transferring to the warehouse process of FIG. 25 or engineering;

FIG. 27 is a block diagram flow chart of a process to segregate, contain and control product and material found to be damaged/non-conforming;

FIG. 28 is a block diagram flow chart of a process to conduct 1^{st} article activities;

FIG. 29 is a block diagram flow chart of a process for preparing to perform a 1^{st} article inspection;

FIGS. 30a, 30b and 30c are block diagram flow charts of a process to conduct 1^{st} article inspection;

FIG. 31 is a block diagram flow chart of a process for reviewing a prototype container/dunnage;

FIG. 32 is a block diagram flow chart of a process to conduct release-for-production-design phase activities;

FIGS. 33a and 33b are block diagram flow charts of a process for identifying, approving and implementing field order changes (FOC);

FIG. 34 is a screen shot of a containers window which contains container information and an image of the container; standard instructions for loading and unloading the container are also provided;

FIG. 35 is a screen shot of a WIRFs window and a particular, overlapping, WIRF window which depicts a work initiation request form (WIRF);

FIG. 36 is a screen shot of an MRFs window and a particular, overlapping, MRF (i.e., Management Release Form) depicting a MRF form;

FIG. 37 is a screen shot of an FOCs window and a particular, overlapping, field order change (i.e., FOC) window depicting a FOC form;

FIG. 38 is a screen shot of a meeting minutes window and a particular, overlapping, job-related meeting minutes window depicting a meeting minutes form;

FIG. 39 is a screen shot of an in-house requisitions window and a particular, overlapping, in-house purchase requisition window depicting an in-house requisition form; and

FIG. 40 is a screen shot of a customer purchase requisitions window and a particular, overlapping, customer purchase requisitions window depicting a customer requisition form.

### DETAILED DESCRIPTION OF THE PREFERRED EMBODIMENTS

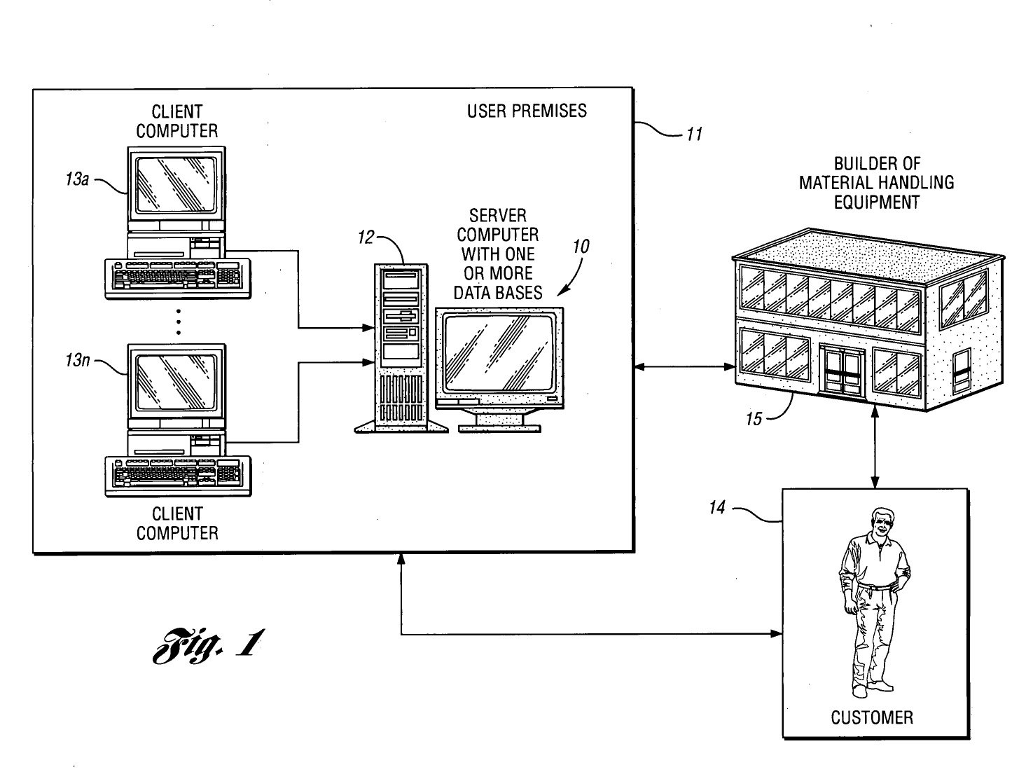

Referring now to the drawing figures, there is shown in FIG. 1, in block diagram form, a computer network-implemented system for carrying out the computer-aided method of the present invention. A computer network, generally indicated at 10, includes a server computer 12 having one or more databases, such as relational databases. The network 10 also includes a number of client computers 13a through 13n. Typically, the computers 12 and 13a-13n are located at the user premises 11.

A customer 14 of containers/dunnage is typically in communication with the user premises 11 which is also typically in communication with a builder 15 of material handling equipment such as the container and/or dunnage.

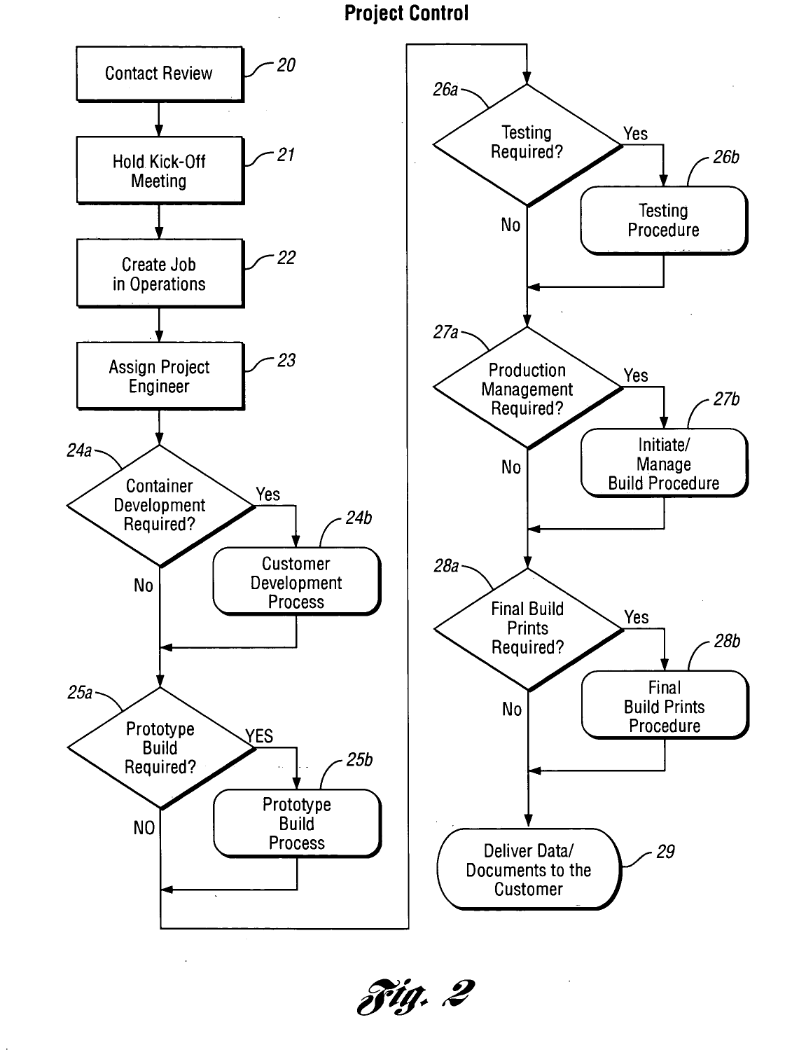

FIG. 2 generally illustrates a project control process of one embodiment of the present invention. Typically, engineers and managers are responsible for the process of FIG. 2.

At block 20, initially a contract review is held. At block 21, a kick-off meeting is held. At block 22, a job in an operations database is created. At block 23, a project engineer is assigned.

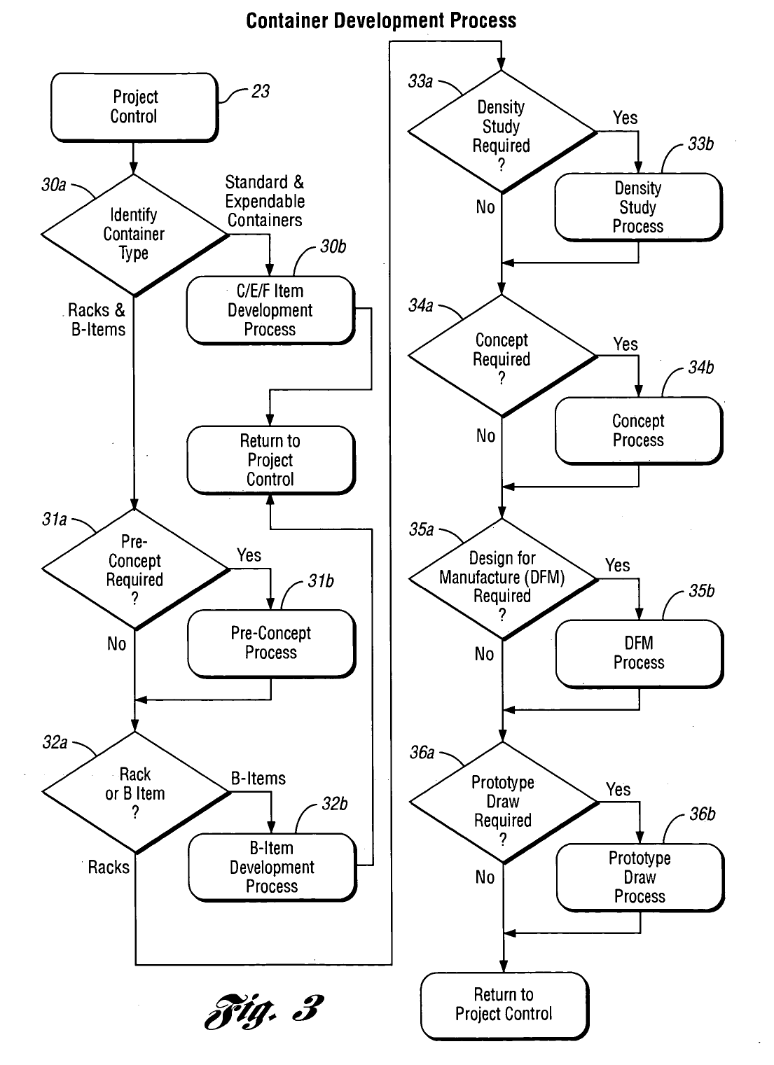

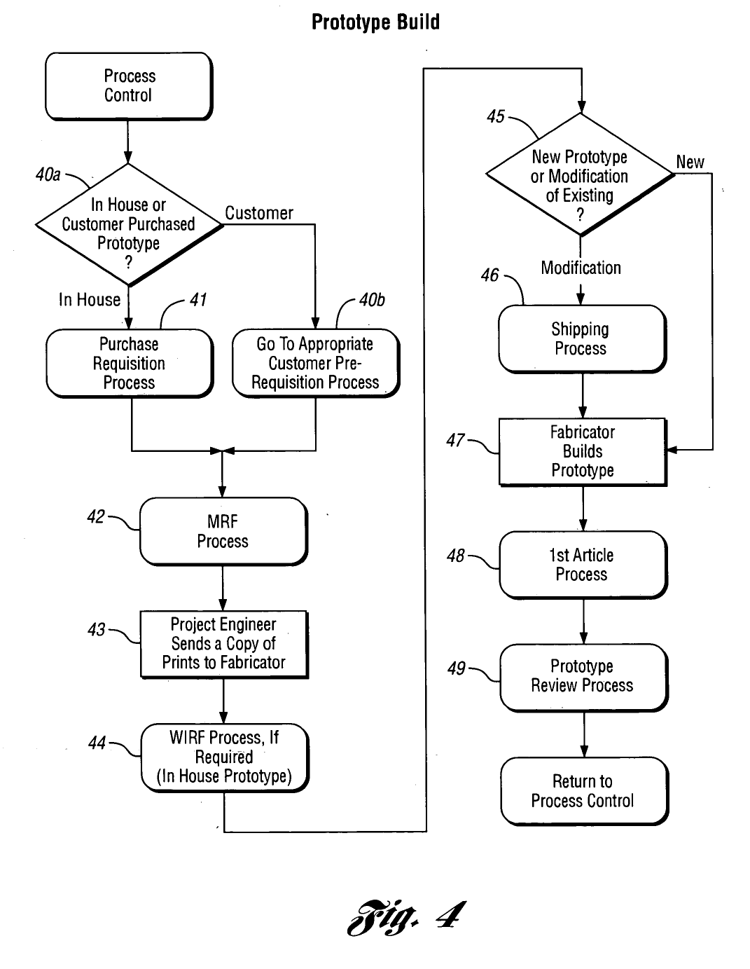

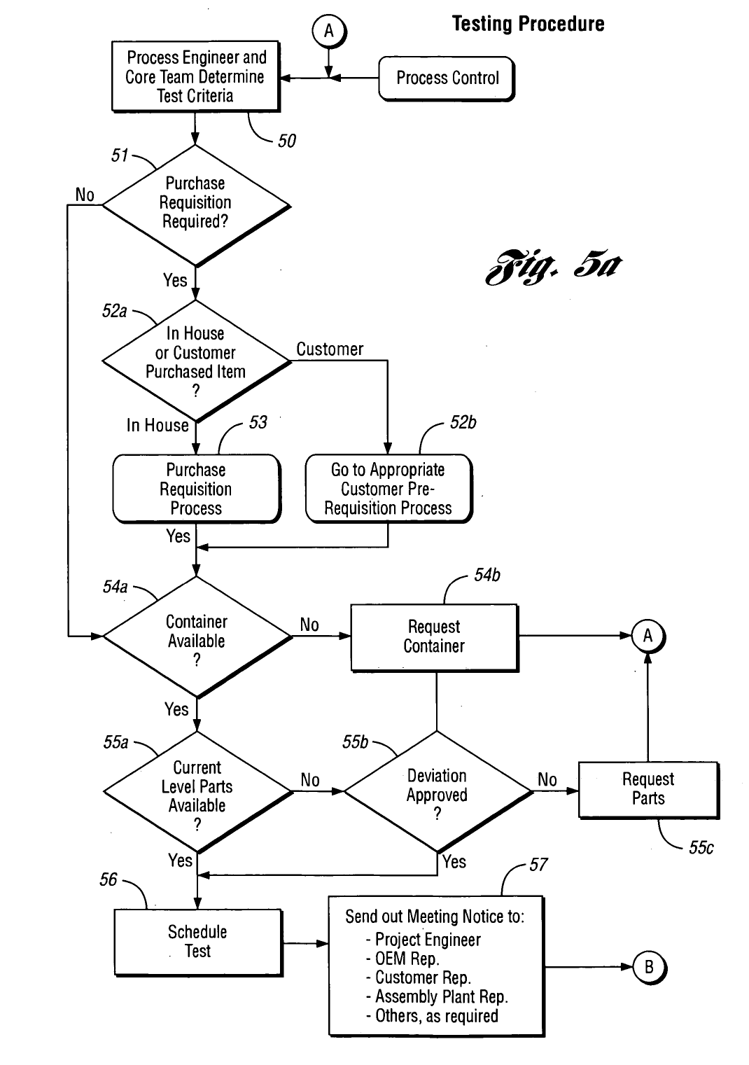

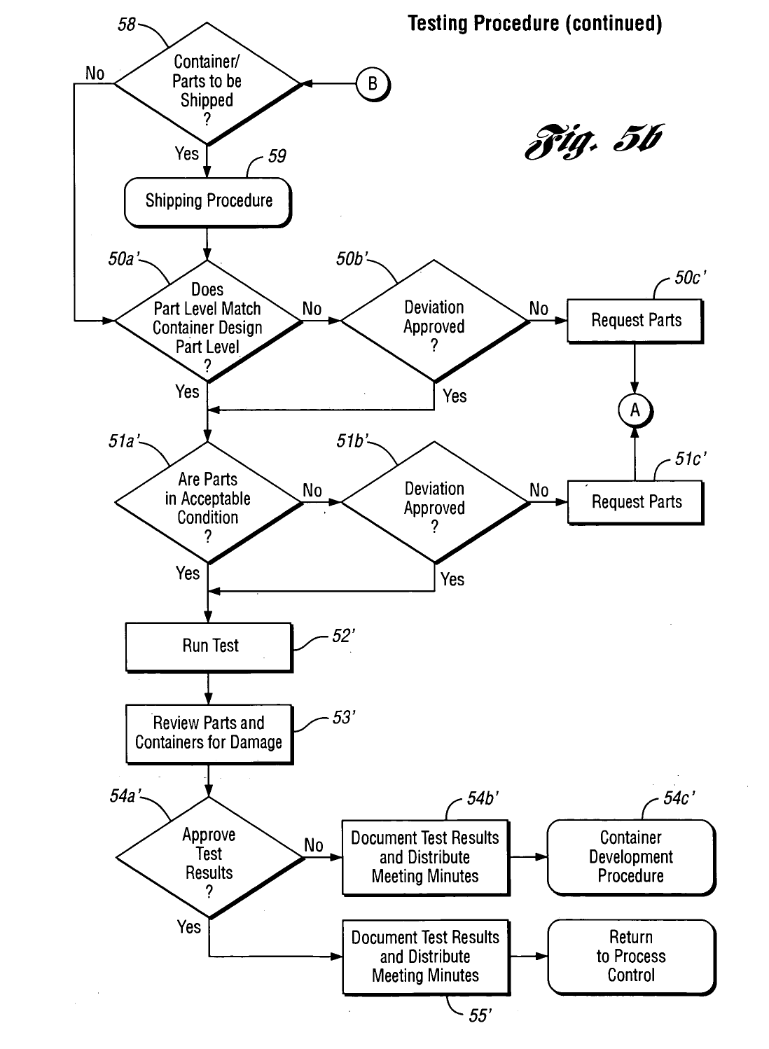

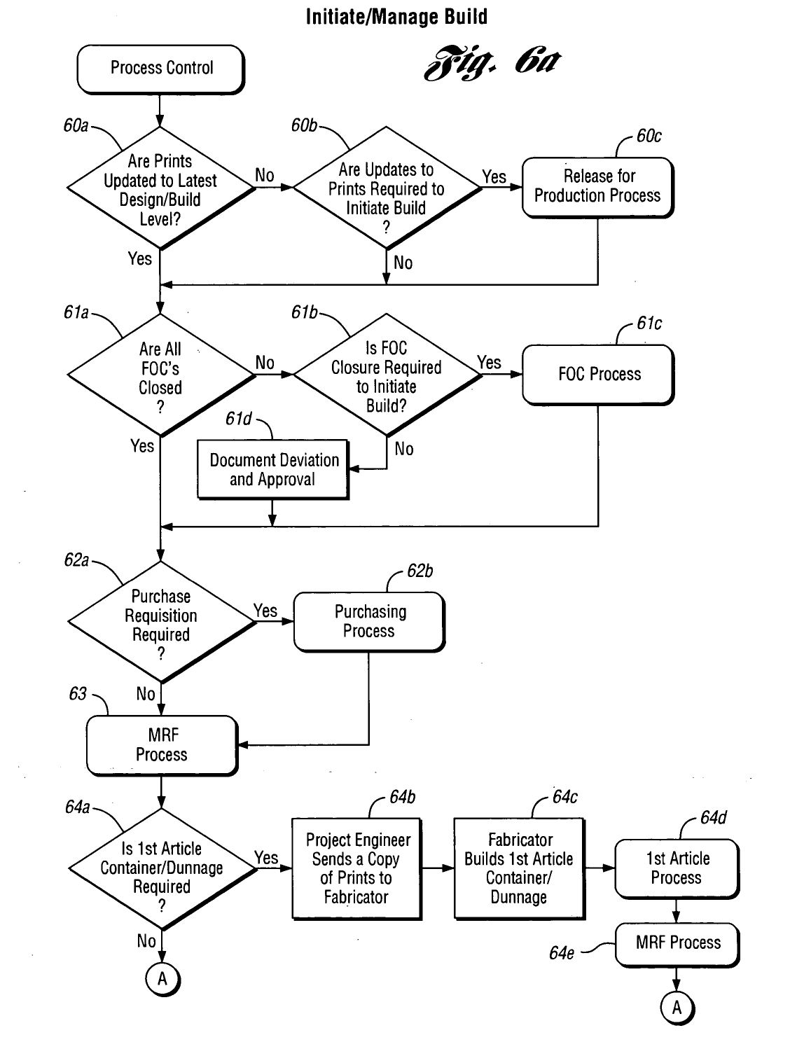

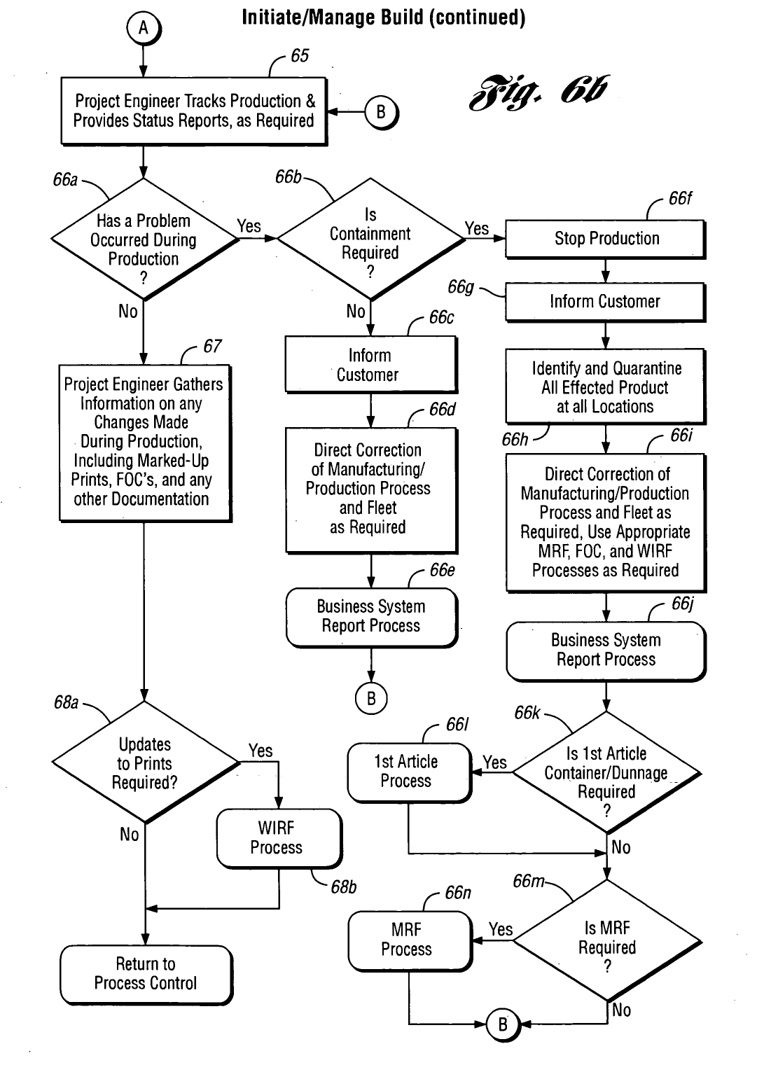

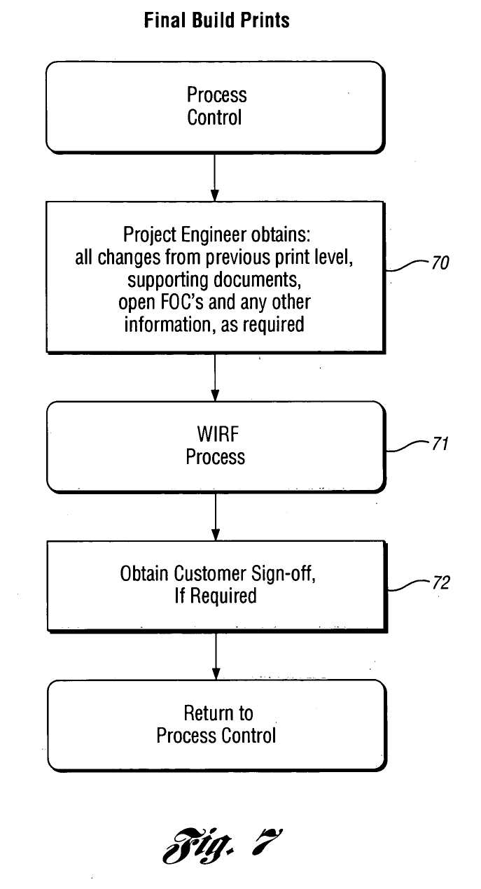

At block 24a, determine if container development required. If yes, at block 24b, implement a container development process of FIG. 3. If no, at block 25a, determine if a prototype build is required. If yes, at block 25b, implement a prototype build process of FIG. 4. If no, at block 26a, determine if testing required. If yes, at block 26b, implement a testing procedure of FIGS. 5a and 5b. If no, at block 27a, determine if production management is required. If yes, at block 27b, implement a initiate/manage build procedure of FIGS. 6a and 6b. If no, at block 28a, determine if final build prints are required. If yes, at block 28b, implement a final build prints procedure of FIG. 7. If no, at block 29, the data/documents are delivered to the customer.

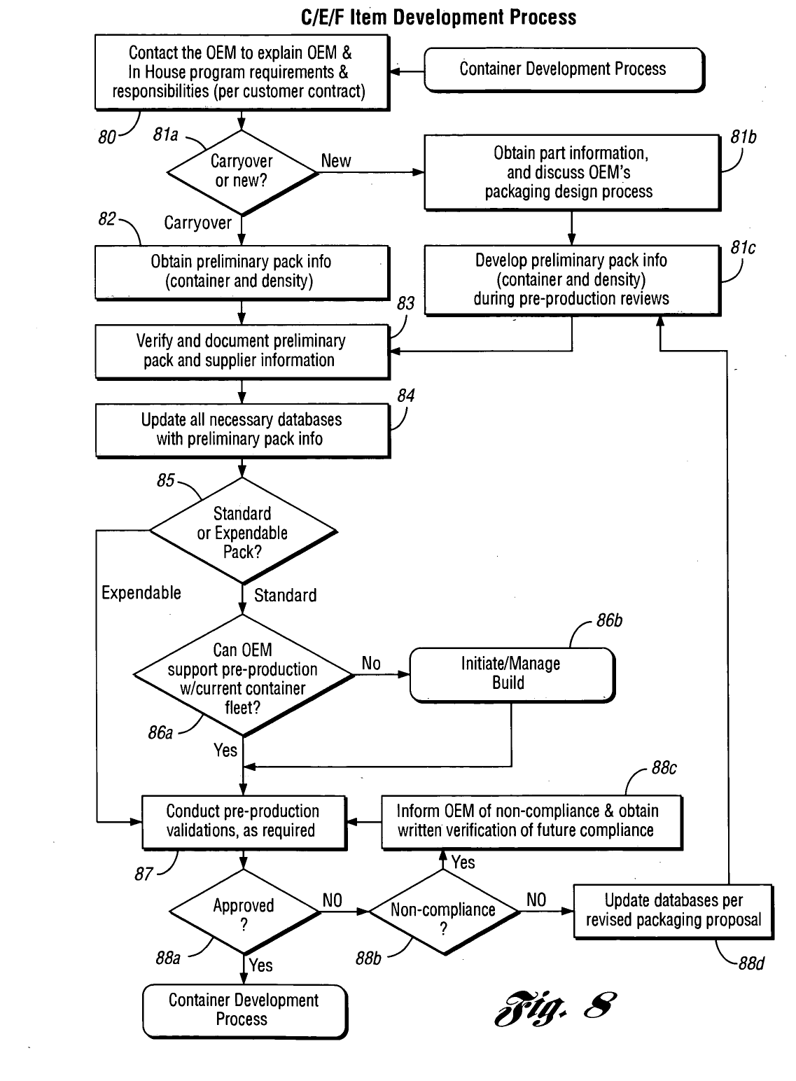

FIG. 3 illustrates the container development process which is typically entered from the project control process of FIG. 2. At block 30a, the container type is identified. If a standard or expendable container is identified, at block 30b, implement a C/E/F item development process of FIG. 8 and then return to project control of FIG. 2.

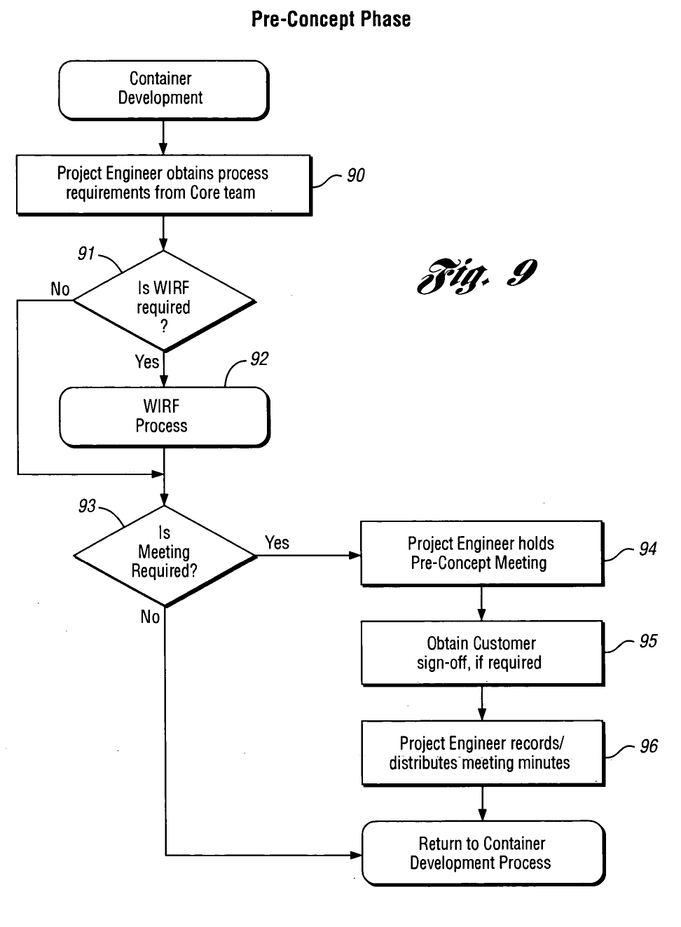

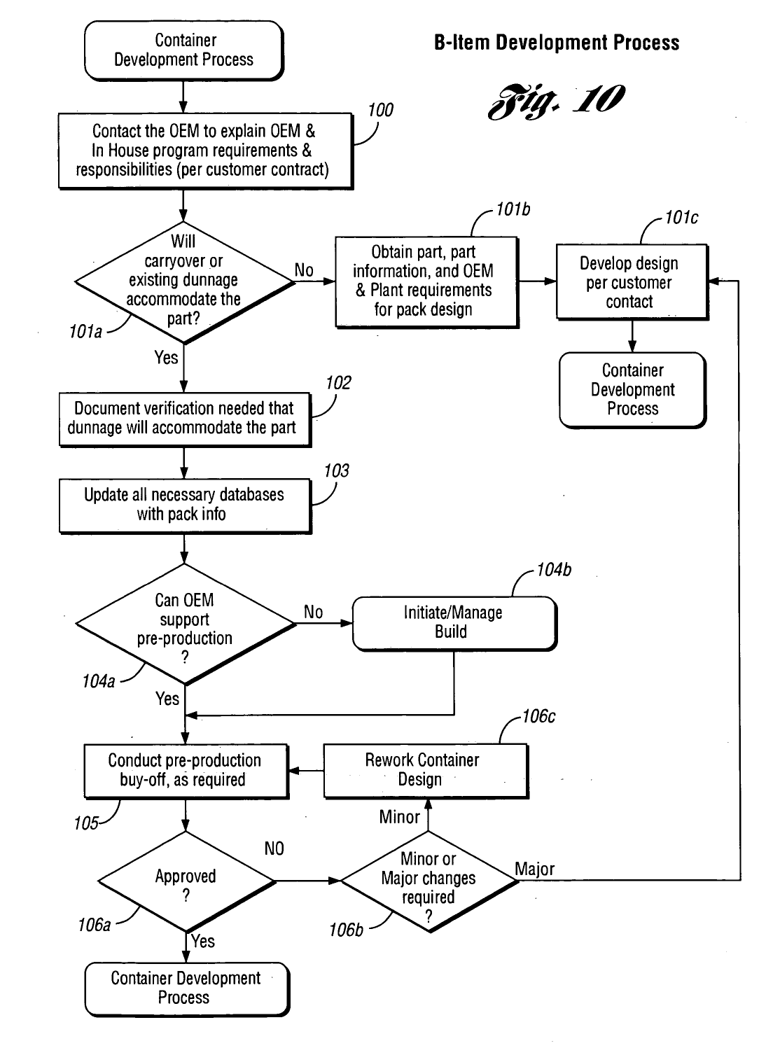

If a rack or B-item is identified, at block 31a, determine if a pre-concept process is required. If yes, at block 31b, implement a pre-concept process of FIG. 9. If no, at block 32a, determine if the container is a rack or B-item (i.e., dunnage). If a B-item, at block 32b, implement a B-item development process of FIG. 10. Then, go back to the project control of FIG. 2.

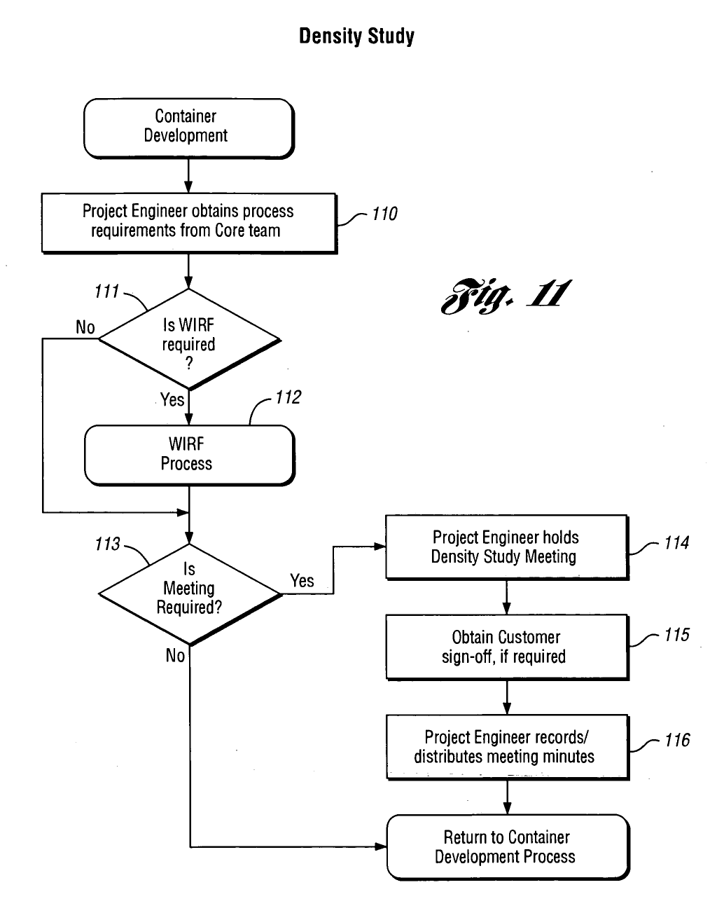

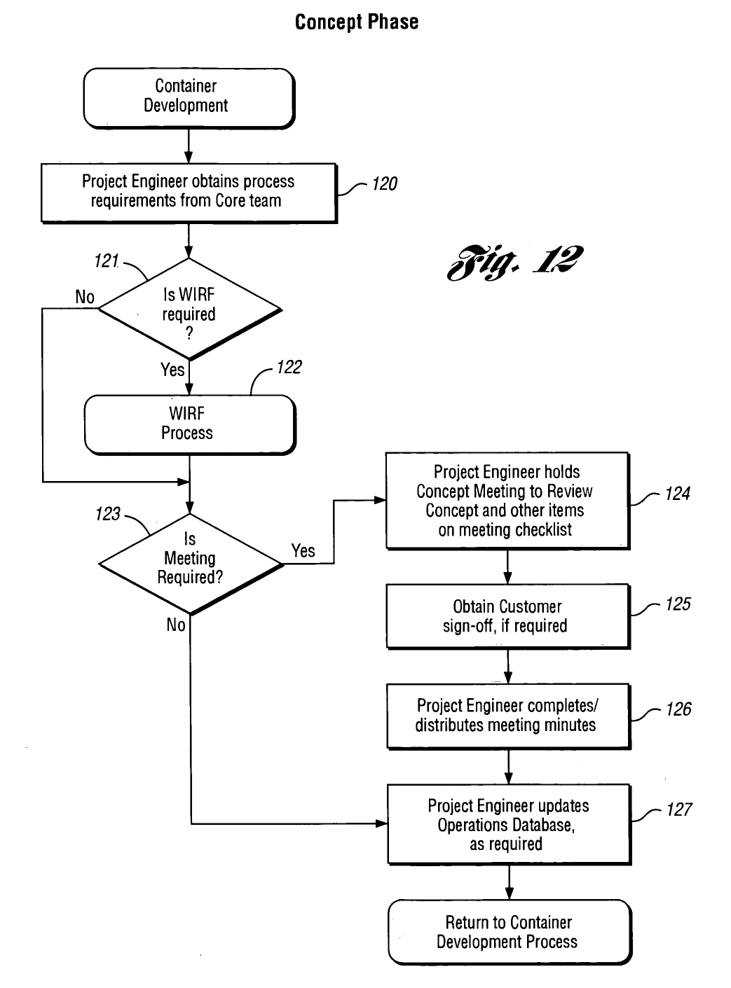

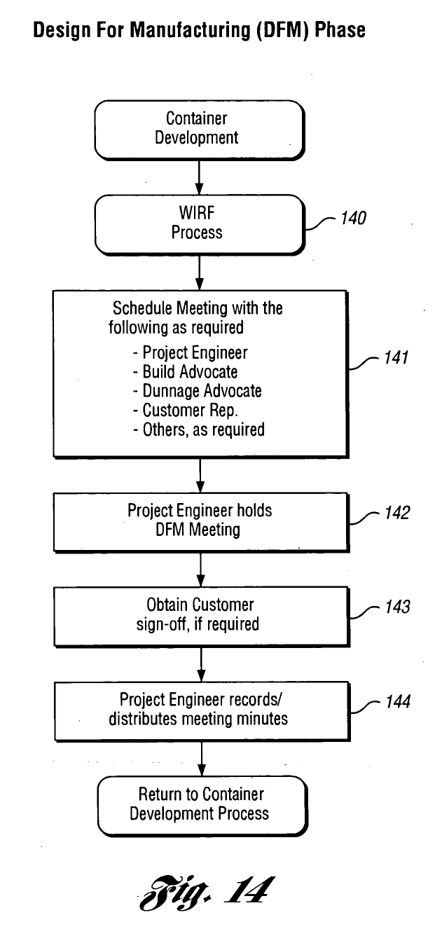

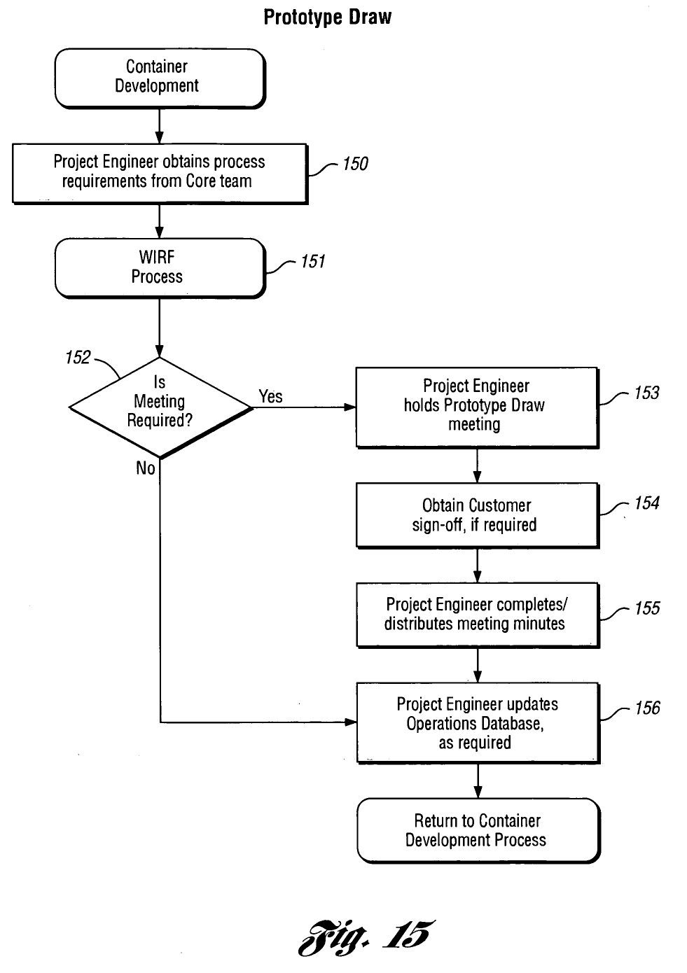

If a rack, at block 33a, determine if a density study is required. If yes, at block 33b, implement a density study process of FIG. 11. If no, at block 34a, determine if a concept process is required. If yes, at block 34b, implement a concept process of FIG. 12. If no, at block 35a, determine if a design for manufacture (DFM) process is required. If yes, at block 35b, implement a DFM process of FIG. 14. If no, at block 36a, determine if a prototype draw process is required. If yes, at block 36b, implement a prototype draw process of FIG. 15. If no, return to the project control of FIG. 2.

FIG. 4 illustrates in detail the prototype build process noted in FIG. 2.

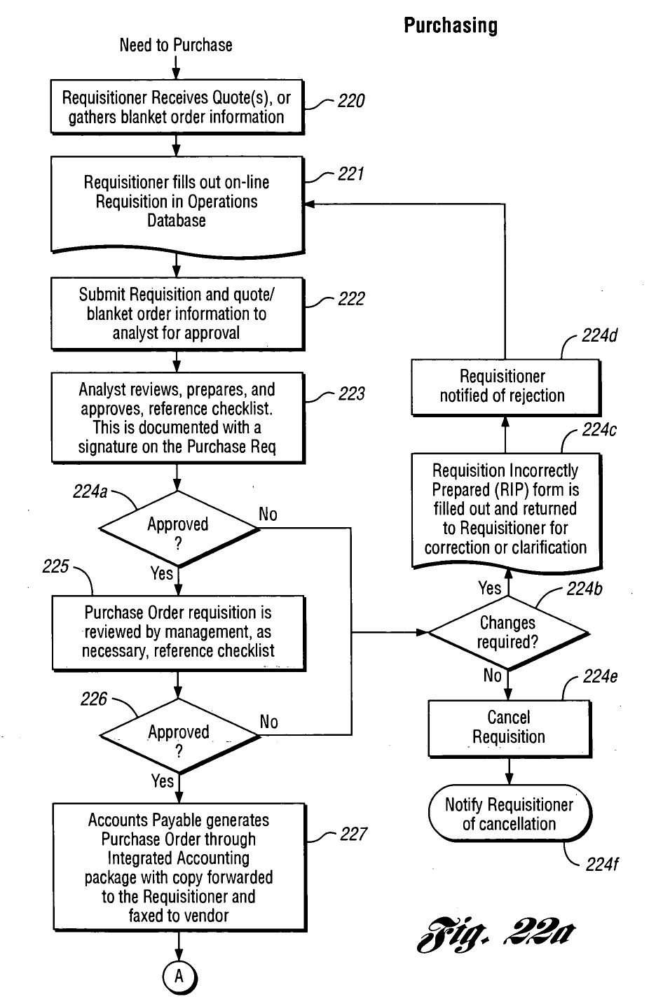

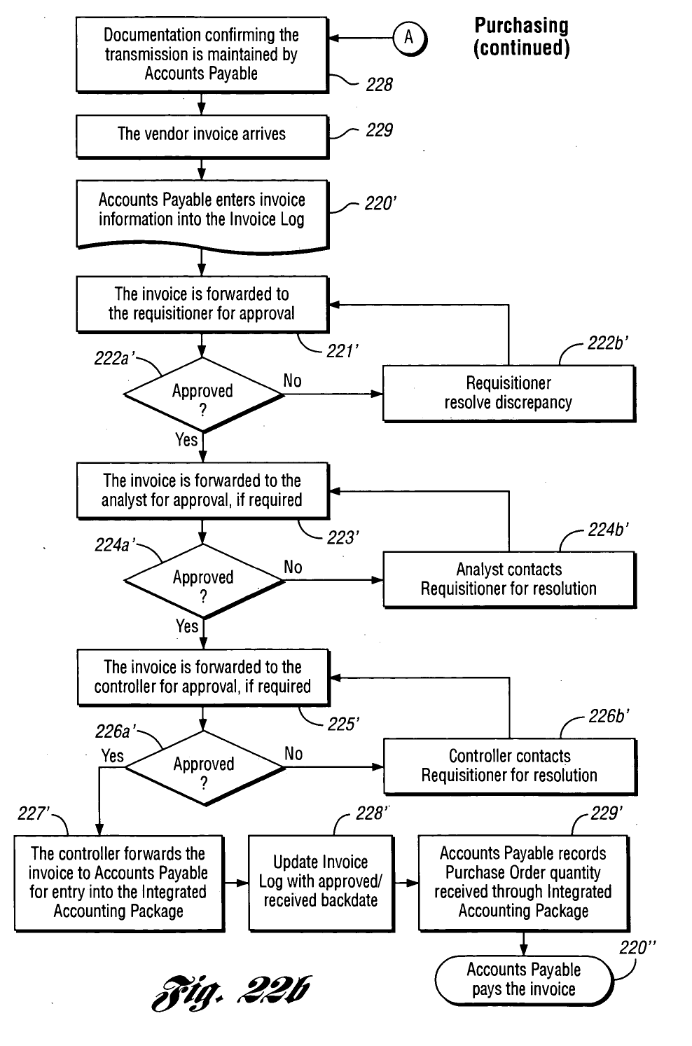

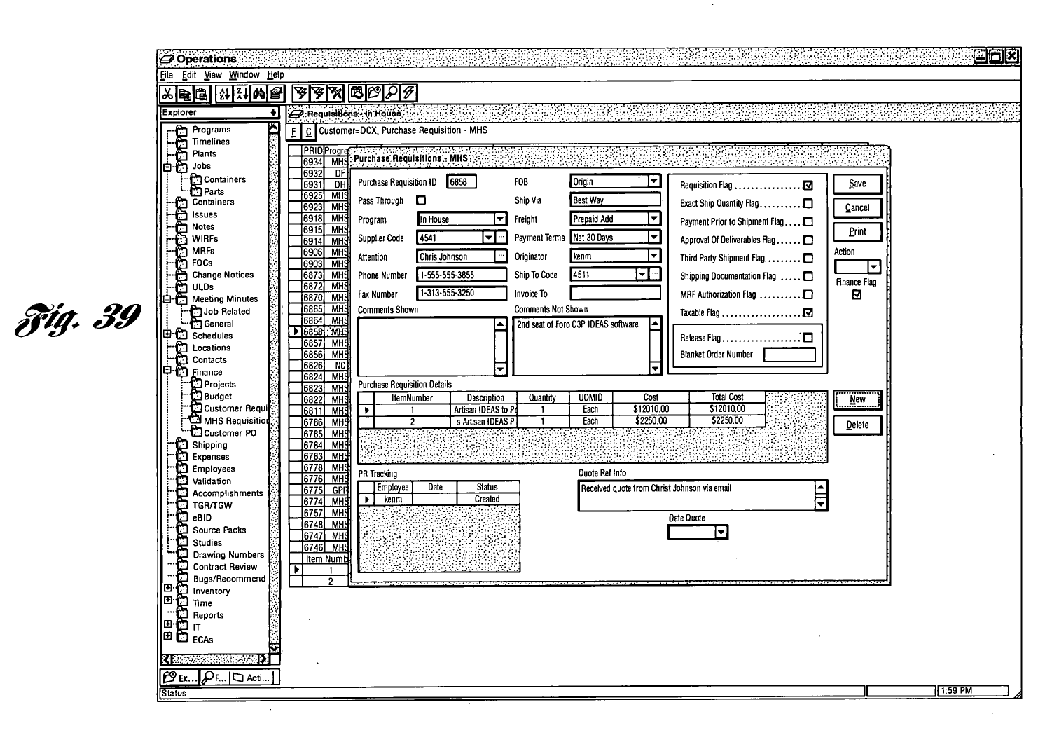

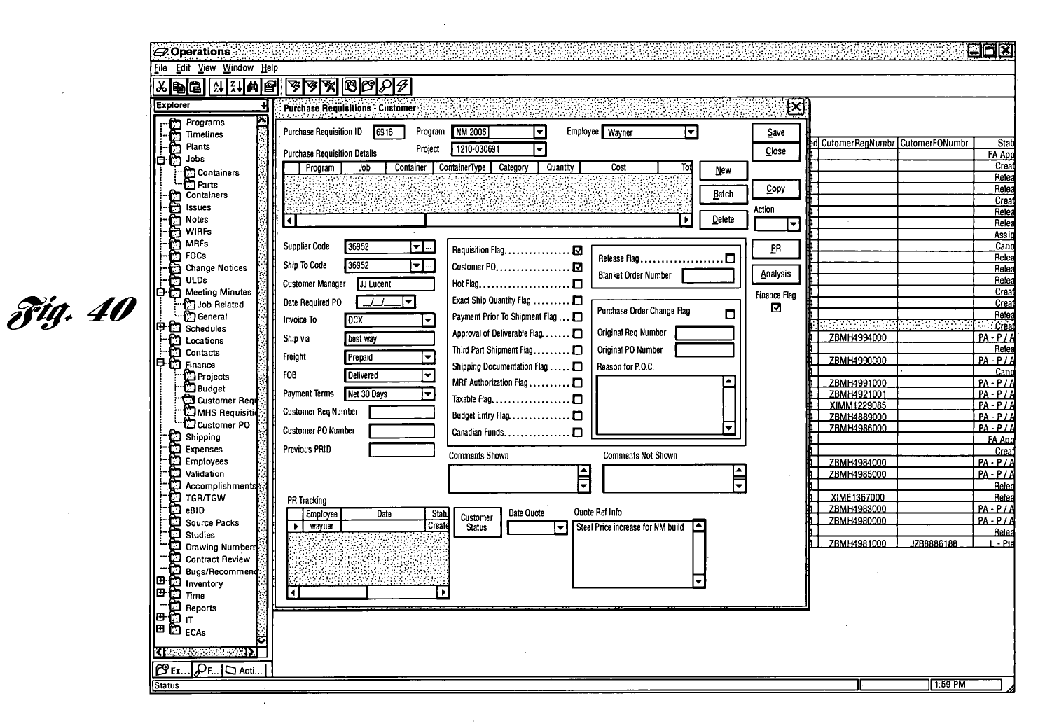

At block 40a, determine if the prototype is in-house or customer purchased. If customer purchased, at block 40b, implement an appropriate customer pre-requisition process (i.e., see FIG. 40). If in-house, at block 41, implement a purchase requisition process of FIGS. 22a and 22b (also FIG. 39).

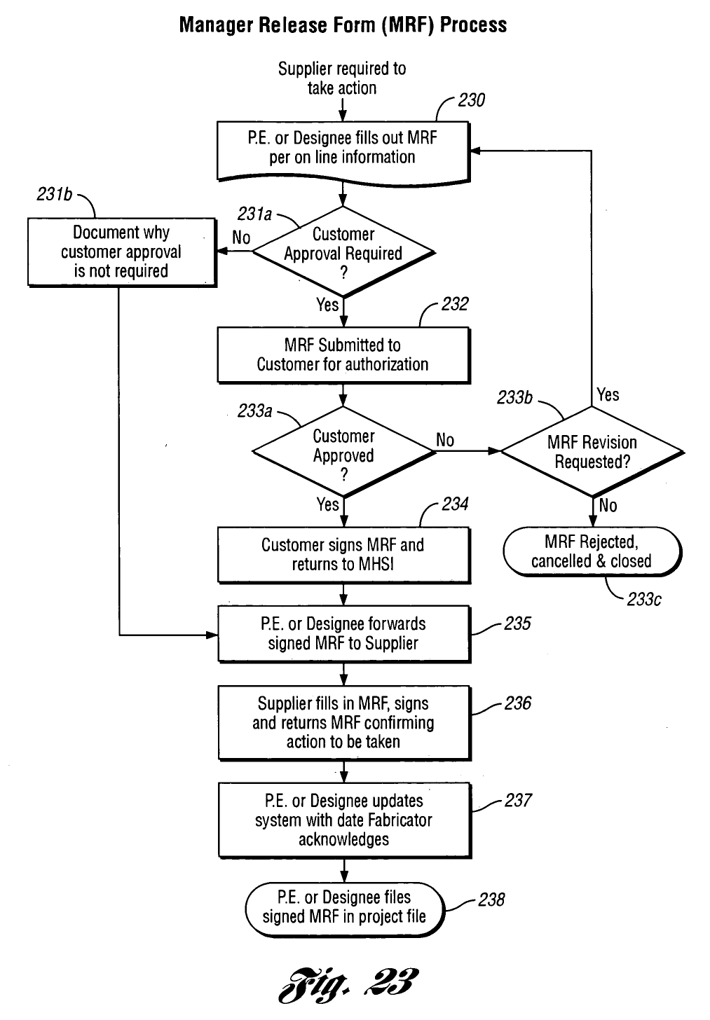

At block 42, implement an MRF process of FIG. 23.

At block 43, a project engineer sends a copy of prints to a fabricator.

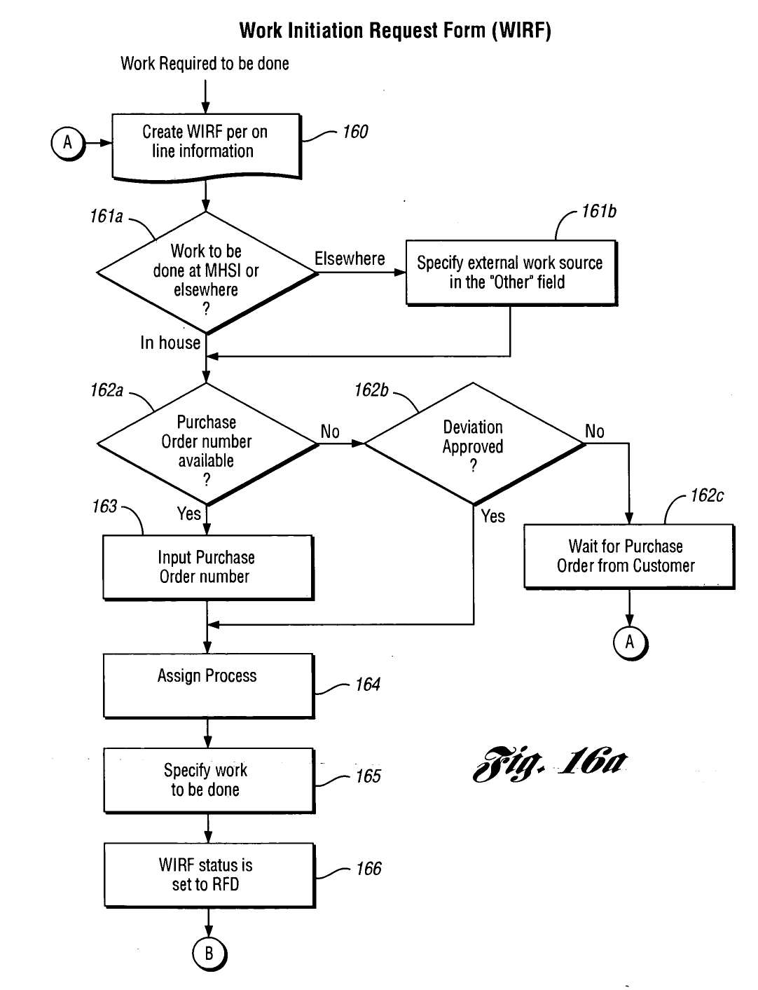

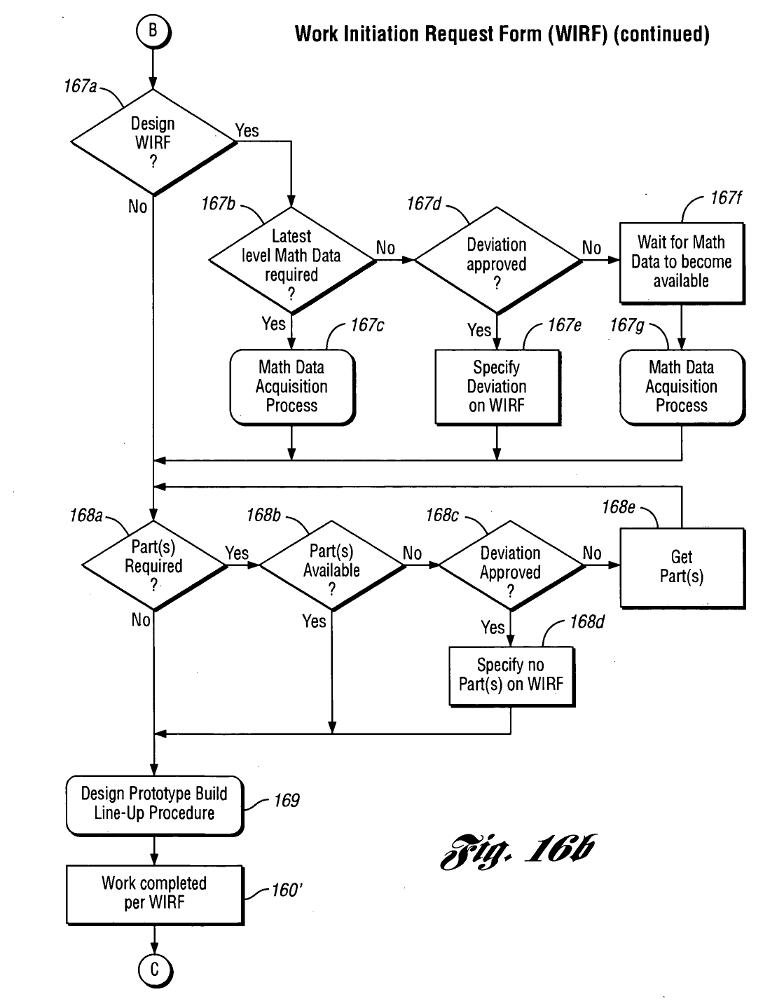

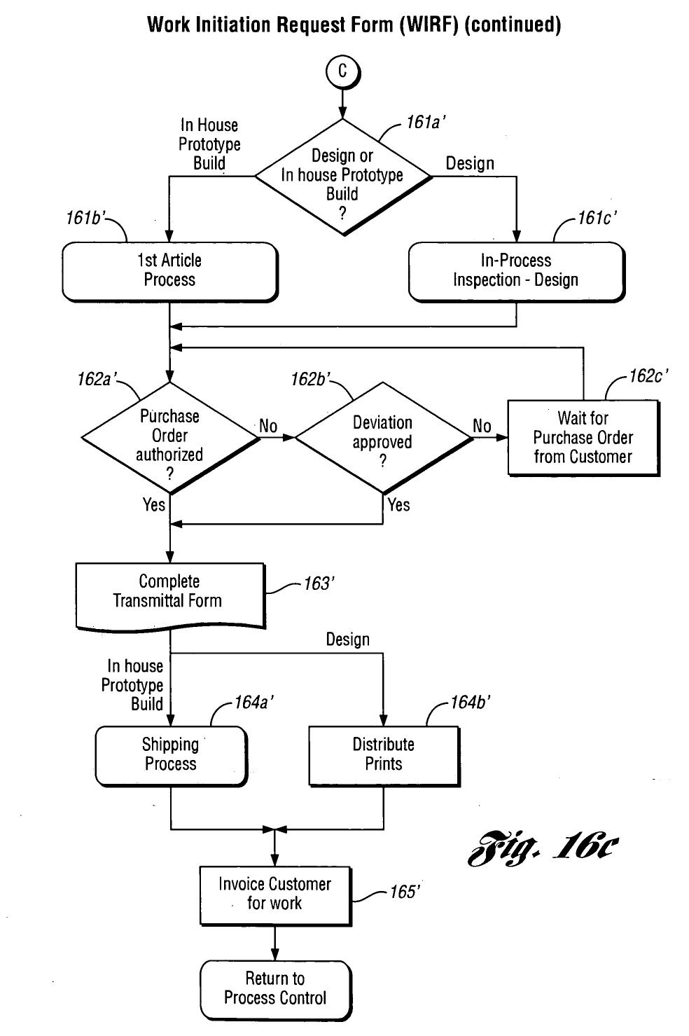

At block 44, implement WIRF process, if required (in-house prototype) of FIGS. 16a and 16b.

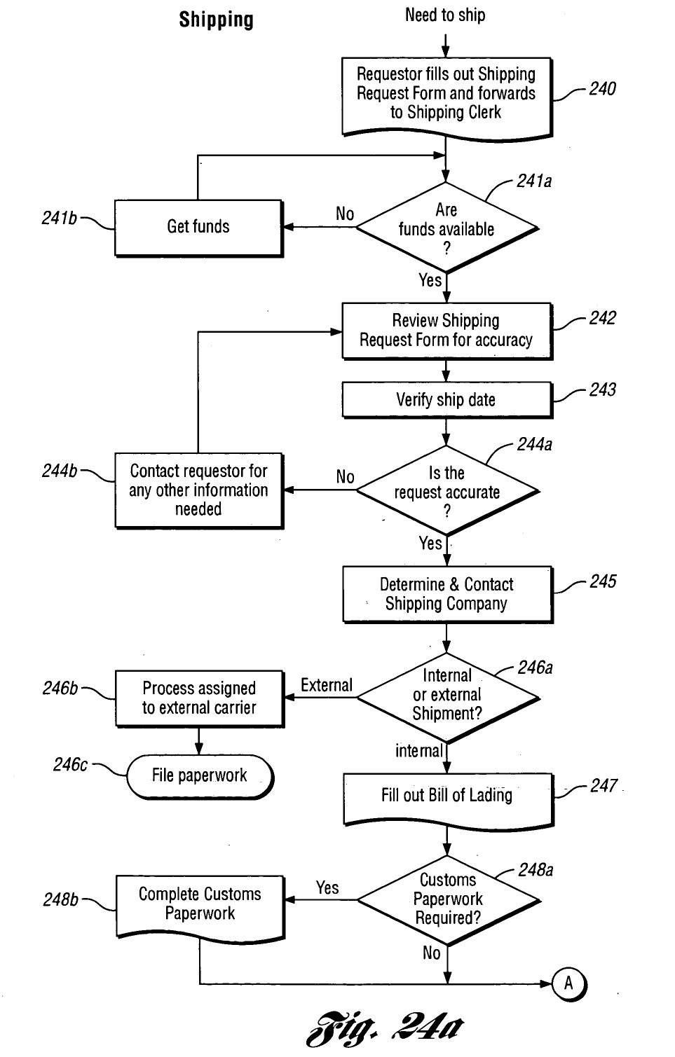

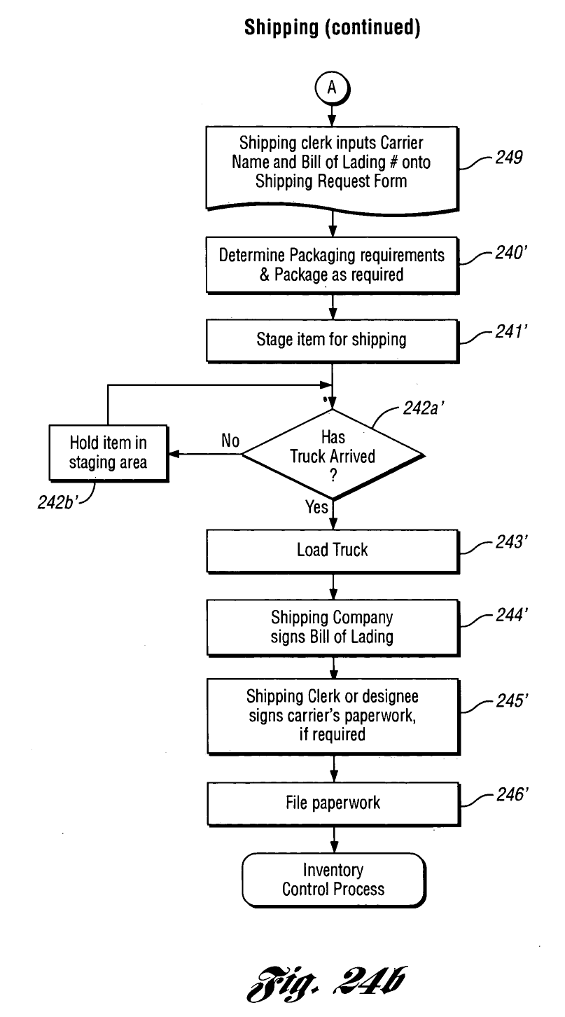

At block 45, determine if it is a new prototype or a modification of an existing prototype. If it is a modification, at block 46, implement a shipping process of FIG. 24. Then, or if the answer to block 45 is “new,” at block 47, a fabricator builds the prototype.

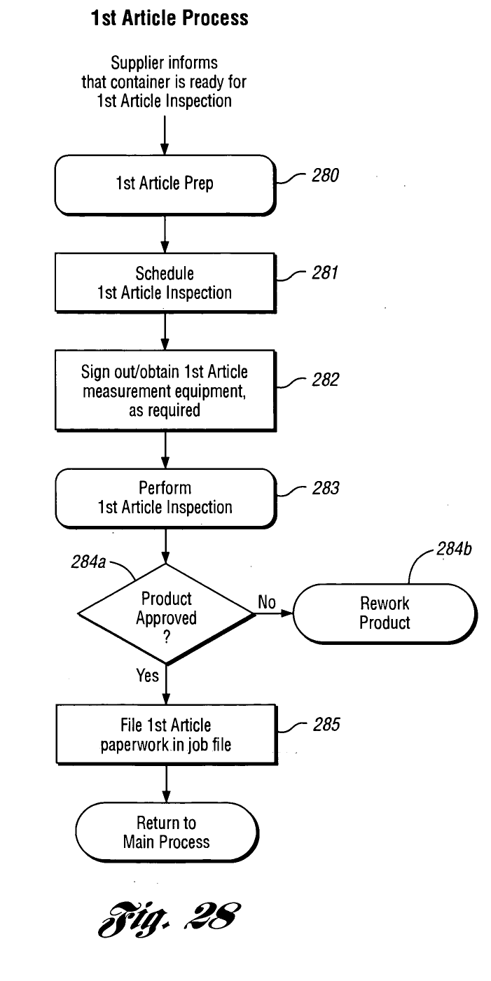

At block 48, implement 1^{st} article (i.e., pre-production) process of FIG. 28.

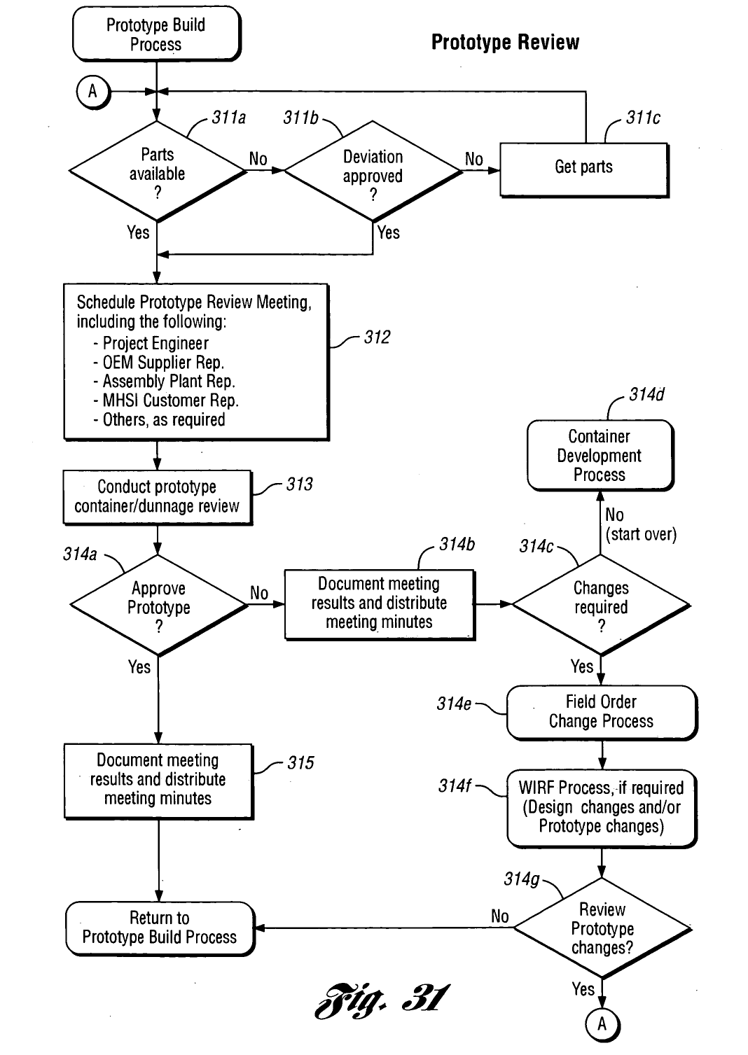

At block 49, implement a prototype review process of FIG. 31. Then go back to process control of FIG. 2.

FIG. 5a illustrates the testing procedure of FIG. 2. At block 50, a project engineer and a core team determine test criteria. At block 51, determine if a purchase requisition required. If no, go immediately to block 54a. If yes, at block 52a, determine if it is an in-house or customer purchased item. If customer purchased, at block 52b, implement an appropriate customer pre-requisition process (see FIG. 40).

If purchased in-house, at block 53, implement the purchase requisition process of FIGS. 22a and 22b (see also FIG. 39).

At block 54a, determine if a container is available. If not, at block 54b, a container is requested and then the process goes back to block 50. If yes, at block 55a, determine if current level parts are available. If not, at block 55b, determine if a deviation to the process is approved. If not, at block 55c, a request for parts is made and the process goes back to block 50. If yes, at block 56, a test is scheduled.

At block 57, a meeting notice is sent to the project engineer, the OEM representative, the customer representative, the assembly plant representative, and others, as required. Then, the testing procedure continues as indicated in FIG. 5b which further illustrates the testing procedure.

At block 58, determine if the container/parts are to be shipped. If not, go directly to block 50a′. If yes, at block 59, implement a shipping procedure of FIG. 24.

At block 50a′, determine if part level matches the container design part level. If not, at block 50b′, determine if a deviation is approved. If not, at block 50c′, implement a request for parts and go back to block 50. If yes, at block 51a′, determine if parts are in acceptable condition. If no, at block 51b′, determine if a deviation is approved. If not, at block 51c′, implement a request for parts and go back to block 50. If yes, at block 52′, implement a run test.

At block 53′, a review of parts and containers for damage is conducted.

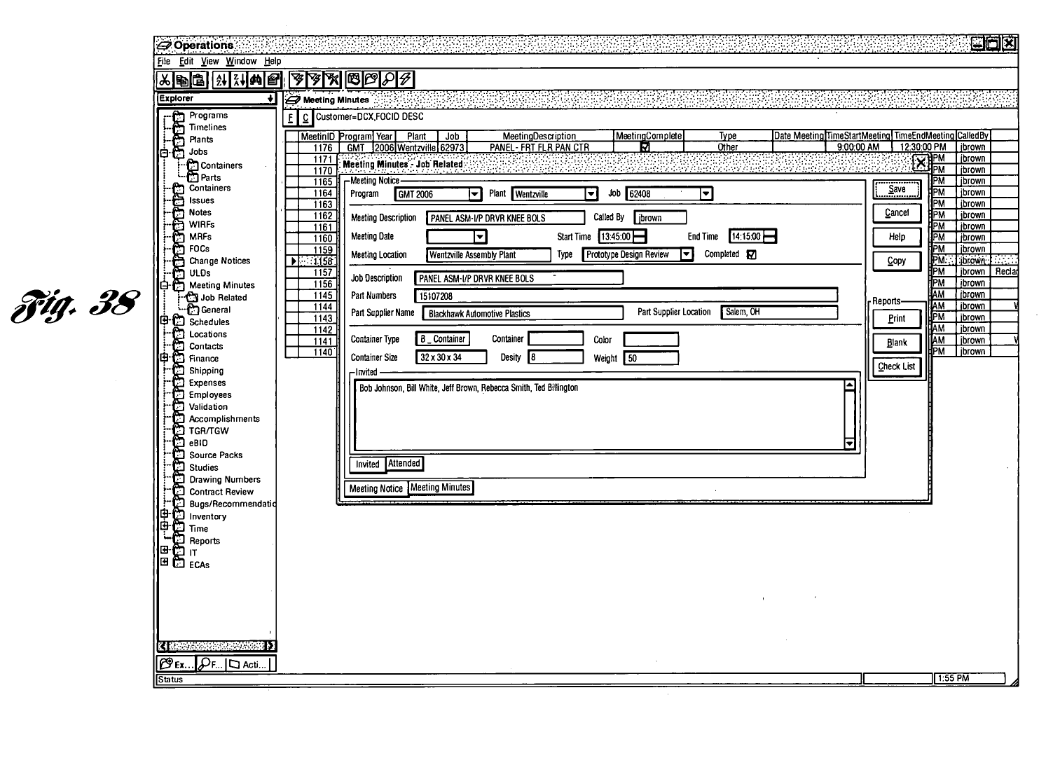

At block 54a′, determine if the test results are approved. If not, at block 54b′, document test results and distribute meeting minutes. Also, put meeting minutes in the database (see FIG. 38). Then, at block 54c′, implement the container development procedure (i.e., FIG. 3).

If the test results are approved, at block 55′, document the test results and distribute meeting minutes (also FIG. 28). Then, go back to process control of FIG. 2.

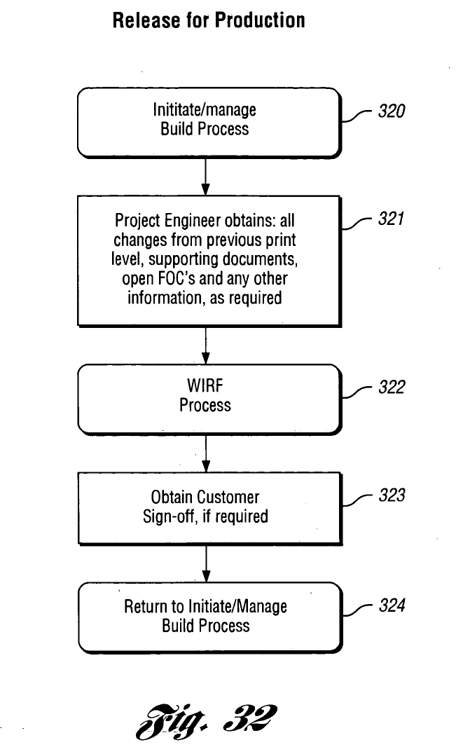

FIG. 6a illustrates the initiate/manage build process of FIG. 2. At block 60a, determine if prints are updated to latest design/build level. If not, at block 60b, determine if updates to the prints are required to initiate build. If yes, at block 60c, implement a release for production process of FIG. 32.

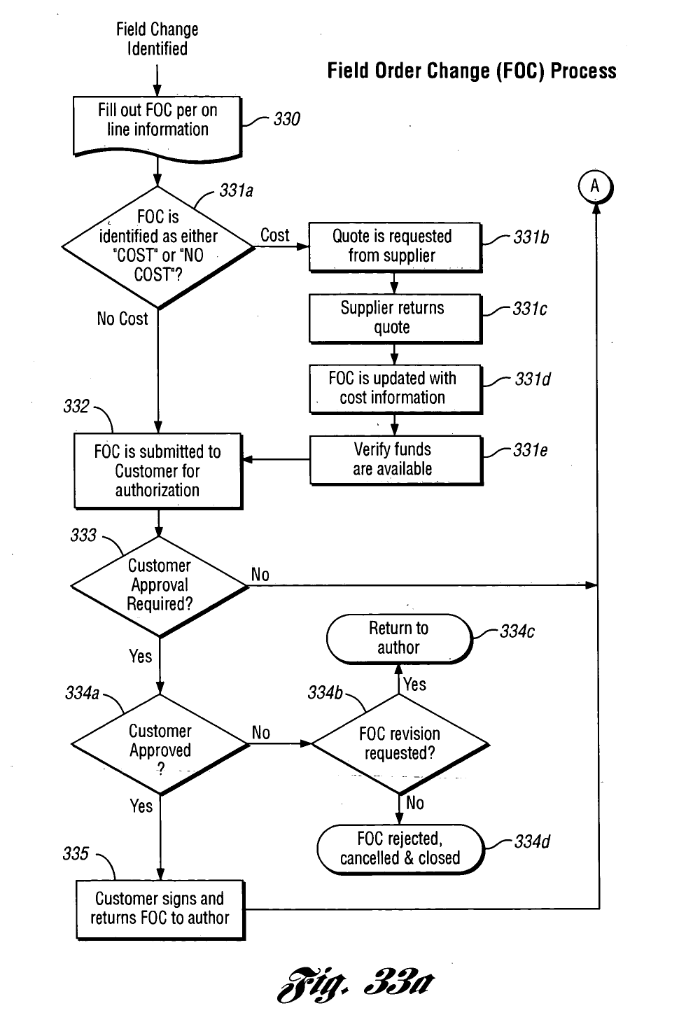

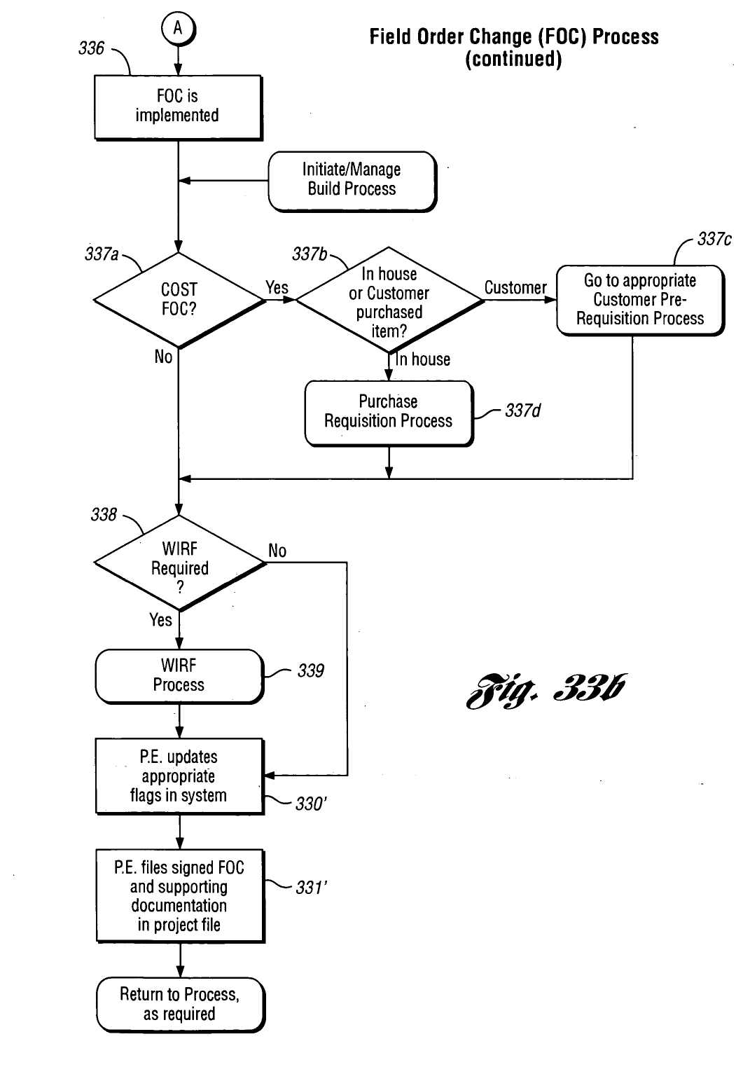

At block 61a, determine if all FOCs (i.e., field order changes) are closed. If not, at block 61b, determine if a FOC closure is required to initiate build. If yes, at block 61c, implement the FOC process of FIG. 33. If no, at block 61d, implement document deviation and approval.

At block 62a, determine if a purchase requisition is required. If yes, at block 62b, implement the purchasing process of FIGS. 22a and 22b. If no, at block 63, implement the MRF process of FIG. 23.

At block 64a, determine if 1^{st} article (i.e., pre-production) container/dunnage is required. If no, go to block 65 of FIG. 6b. If yes, at block 64b, the project engineer sends a copy of the prints to a fabricator. At block 64c, the fabricator builds the 1^{st} article container/dunnage. At block 64d, implement the 1^{st} article process of FIG. 28. Then, at block 64e, implement the MRF process of FIG. 23 and then go to block 65 of FIG. 6b which further illustrates the initiate/manage build process.

At block 65, the project engineer tracks production and provides status reports, as required. At block 66a, determine if a problem has occurred during production. If yes, at block 66b, determine if containment is required. If not, at block 66c, the customer is informed. At block 66d, correction of manufacturing/production process and fleet, as required, is directed and at block 66e, implement a business system report process.

If the answer to block 66b is yes, at block 66f, production is stopped, at block 66g, the customer is informed and at block 66h, identify and quarantine all effected product at all locations.

At block 66i, correction of manufacturing/production process and fleet as required, is directed using the appropriate MRF, FOC, and WIRF processes, as required. Then, at block 66j, implement a business system report process.

At block 66k, determine if 1^{st} article (i.e., pre-production) container/dunnage is required. If yes, at block 66l, implement the 1^{st} article process of FIG. 28. If no, at block 66m, determine if an MRF is required. If no, go directly to block 65. If yes, at block 66n, implement the MRF process of FIG. 23 then go to block 65.

At block 67, the project engineer gathers information on any changes made during production, including marked-up prints, FOCs, and any other documentation. At block 68a, determine if updates to prints required. If no, go back to the process control of FIG. 2. If yes, at block 68b, implement the WIRF process of FIGS. 16a and 16b.

FIG. 7 illustrates the final build prints process of FIG. 2. At block 70, the project engineer obtains all changes from previous print level, supporting documents, open FOCs and any other information, as required. At block 71, implement the WIRF process of FIGS. 16a and 16b. At block 72, customer sign-off, if required, is obtained. Then, the process control of FIG. 2 is returned to.

FIG. 8 illustrates the C/E/F item development process of FIG. 3. At block 80, contact the OEM to explain OEM & in-house program requirements and responsibilities (per customer contract). At block 81a, determine if the container is a carryover or new. If new, at block 81b, obtain part information and discuss OEM's packaging design process. At block 81c, develop preliminary package information (container and density) during pre-production reviews.

If the answer to block 81a is “carry over,” at block 82, obtain preliminary pack information (container and density). At block 83, verify and document preliminary pack and supplier information. At block 84, update all necessary databases with preliminary pack information. At block 85, determine if the container is standard or an expendable package. If expendable, go directly to block 87. If standard, at block 86a, determine if OEM support pre-production with current container fleet. If no, at block 86b, implement the initiate/manage build process of FIGS. 6a and 6b. If yes, at block 87, conduct pre-production validations, as required. At block 88a, determine if approved. If not, at block 88b, determine if non-compliant. If non-compliant, at block 88c, inform OEM of non-compliance and obtain written verification of future compliance. Then go back to block 87. If the answer to block 88b is “no,” at block 88d, update databases per revised packaging proposal and go to block 81c. If the answer to block 88a is “yes,” go to the process of FIG. 3.

FIG. 9 illustrates the pre-concept phase of FIG. 3. At block 90, the project engineer obtains process requirements from the core team. At block 91, determine if a WIRF is required. If no, go directly to block 93. If yes, at block 92, implement the WIRF process of FIGS. 16a, 16b and 16c.

At block 93, determine if a meeting is required. If no, go directly to the process of FIG. 3. If yes, at block 94, the project engineer holds a pre-concept meeting. At block 95, obtain customer sign-off, if required. At block 96, the project engineer records/distributes meeting minutes (see FIG. 38).

FIG. 10 illustrates the B-item development process of FIG. 3. At block 100, contact the OEM to explain OEM and in-house program requirements and responsibilities (per customer contract). At block 101a, determine if carryover or existing dunnage will accommodate the part. If no, at block 101b, obtain part, part information, and OEM and plant requirements for package design. At block 101c, develop a design per customer contract and go back to the process of FIG. 3.

If the answer to block 101a is yes, at block 102, document verification needed that dunnage will accommodate the part.

At block 103, update all necessary databases with pack information (see FIG. 38). At block 104a, determine if the OEM can support pre-production. If no, at block 104b, implement the initiate/manage build process of FIGS. 6a and 6b. If yes, at block 105, conduct pre-production buy-off, as required. At block 106a, determine if approved. If yes, go back to the process of FIG. 3. If no, at block 106b, determine if minor or major changes are required. If minor, at block 106c, rework the container design and go back to block 105. If major, go to block 101c.

FIG. 11 illustrates the density study process of FIG. 3.

At block 110, the project engineer obtains process requirements from the core team. At block 111, determine if a WIRF is required. If no, go directly to block 113. If yes, at block 112, implement the WIRF process of FIGS. 16a and 16b.

At block 113, determine if a meeting is required. If no, go back to the process of FIG. 3. If yes, at block 114, the project engineer holds a density study meeting. At block 115, obtain customer sign-off, if required. At block 116, the project engineer records/distributes meeting minutes (see FIG. 38).

FIG. 12 illustrates the concept phase process of FIG. 3. At block 120, the project engineer obtains process requirements from the core team. At block 121, determine if a WIRF is required. If no, go directly to block 123. If yes, at block 122, implement the WIRF process of FIGS. 16a and 16b.

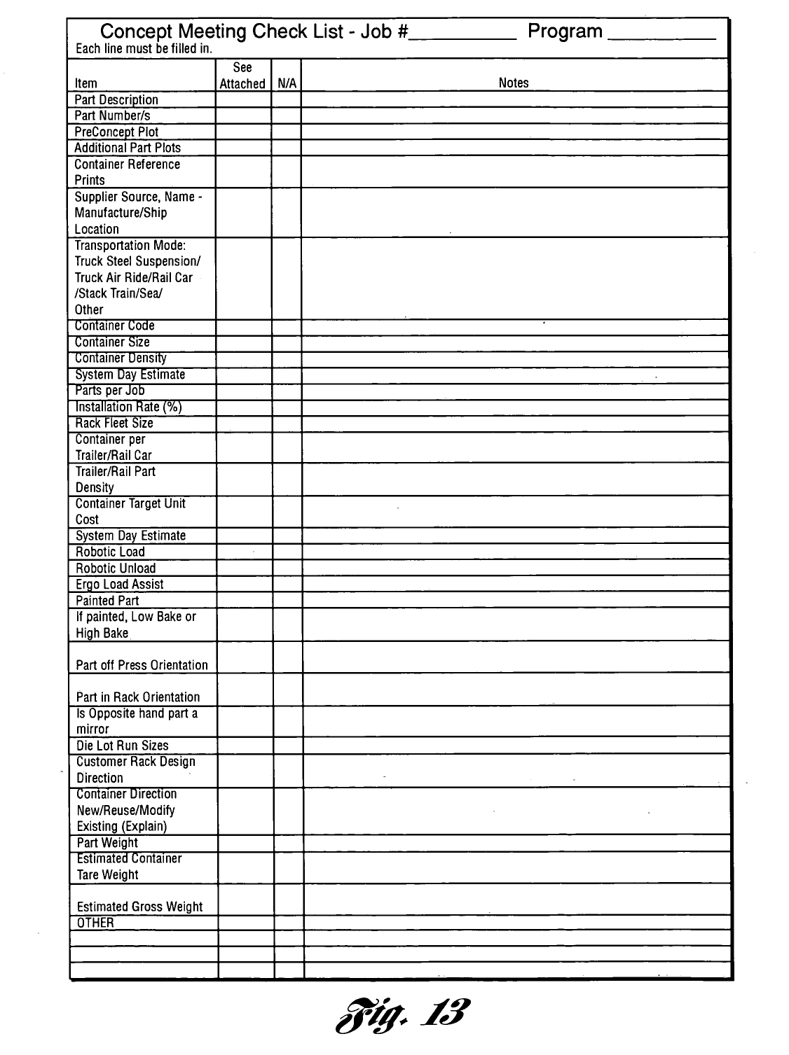

At block 123, determine if a meeting is required. If no, go directly to block 127. If yes, at block 124, the project engineer holds a concept meeting to review the concept and other items on the meeting checklist of FIG. 13, which is completed. The information on the checklist is used to populate the database.

At block 125, obtain customer sign-off, if required. At block 126, the project engineer completes/distributes meeting minutes (see FIG. 38).

At block 127, the project engineer updates the operations database, as required. Then the process returns to the procedure of FIG. 3.

FIG. 13 illustrates the previously mentioned concept meeting checklist.

FIG. 14 illustrates the design for manufacturing (DFM) phase of FIG. 3. At block 140, implement WIRF process of FIGS. 16a and 16b. At block 141, a meeting is scheduled, as required, with the project engineer, the build advocate, the dunnage advocate, the customer representative or others, as required. At block 142, the project engineer holds the DFM meeting. At block 143, obtain customer sign-off, if required. At block 144, the project engineer records/distributes meeting minutes (see FIG. 38) and then returns to FIG. 3.

FIG. 15 illustrates the prototype draw process of FIG. 3. At block 150, the project engineer obtains design directives from core team and/or previous development stages. At block 151, implement the WIRF process of FIGS. 16a and 16b. At block 152, determine if a meeting is required. If no, go directly to block 156. If yes, at block 153, the project engineer holds a prototype draw meeting. At block 154, obtain customer sign-off, if required. At block 155, the project engineer completes/distributes meeting minutes (see FIG. 38).

At block 156, the project engineer updates the operations database, as required (FIG. 38). Then, return is made to the process of FIG. 3.

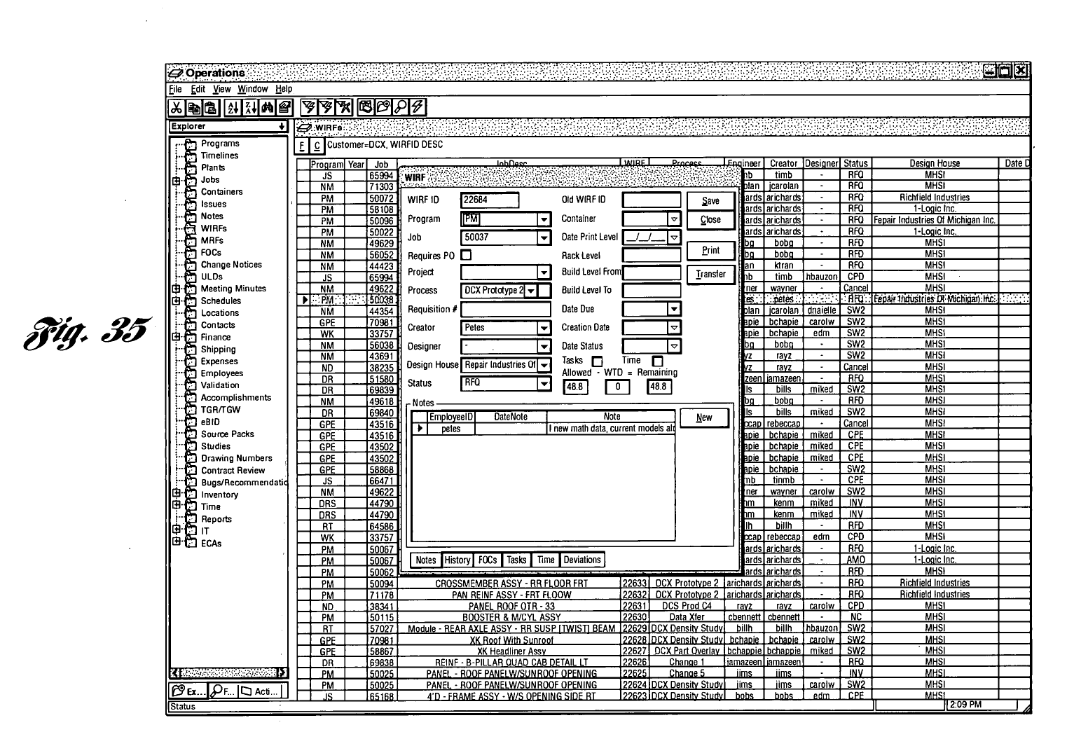

FIGS. 16a, 16b and 16c illustrate the work initiation request form (WIRF) process. At block 160, create a WIRF per on-line information. At block 161a, determine if work is to be done in-house or elsewhere. If elsewhere, at block 161b, specify external work source in the “other” field of the WIRF form (FIG. 35).

If in-house, at block 162a, determine if a purchase order number is available. If not, at block 162b, determine if a deviation is approved. If not, at block 162c, wait for purchase order from customer and return to block 160.

If yes, go to block 163. If the purchase order number is available, at block 163, input the purchase order number. At block 164, assign the process. At block 165, specify work to be done. At block 166, WIRF status on its form (i.e., FIG. 35) is set to RFD.

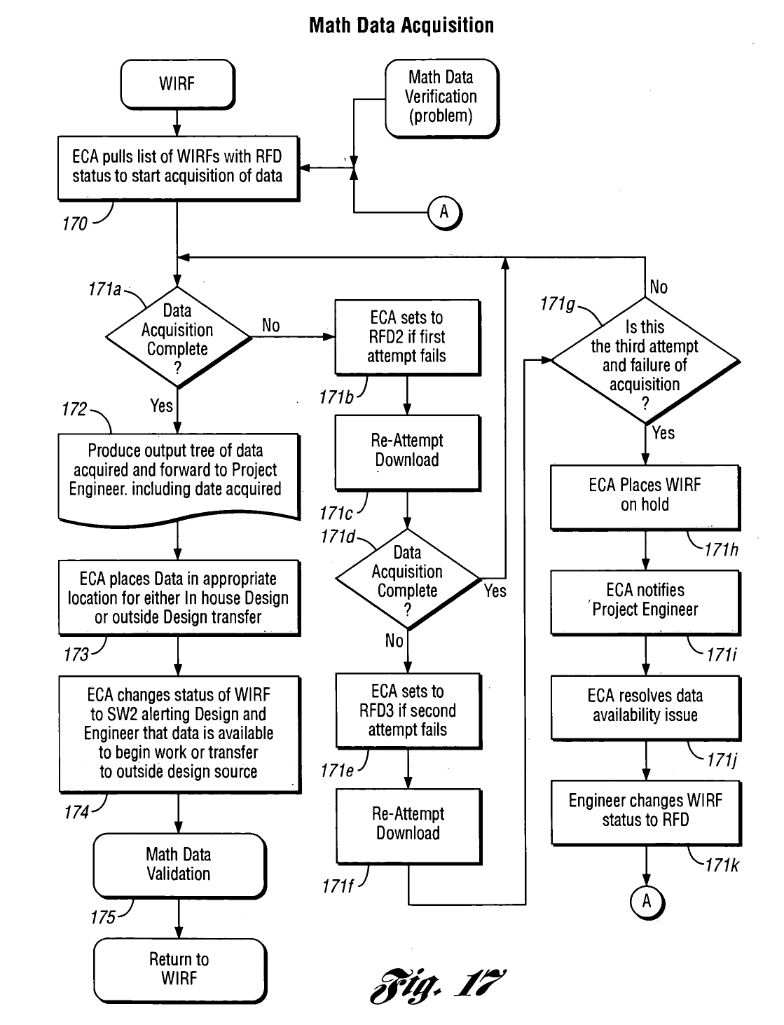

FIGS. 16b and 16c further illustrate the work initiation request form (WIRF) process. At block 167a, determine if the WIRF is a design WIRF. If no, go to block 168a. If yes, at block 167b, determine if latest level math data required. If yes, at block 167c, implement the math data acquisition process of FIG. 17. If no, at block 167d, determine if a deviation is approved.

If yes, at block 167e, specify deviation on the WIRF (i.e., FIG. 35). If no, at block 167f, wait for math data to become available. At block 167g, implement the math data acquisition process of FIG. 17.

At block 168a, determine if part(s) are required. If no, go to block 169. If yes, at block 168b, determine if part(s) available. If yes, go to block 169.

If no, at block 168c, determine if a deviation is approved. If yes, at block 168d, specify no part(s) on the WIRF (i.e., FIG. 35). If no, at block 168e, get part(s) and go back to block 168a.

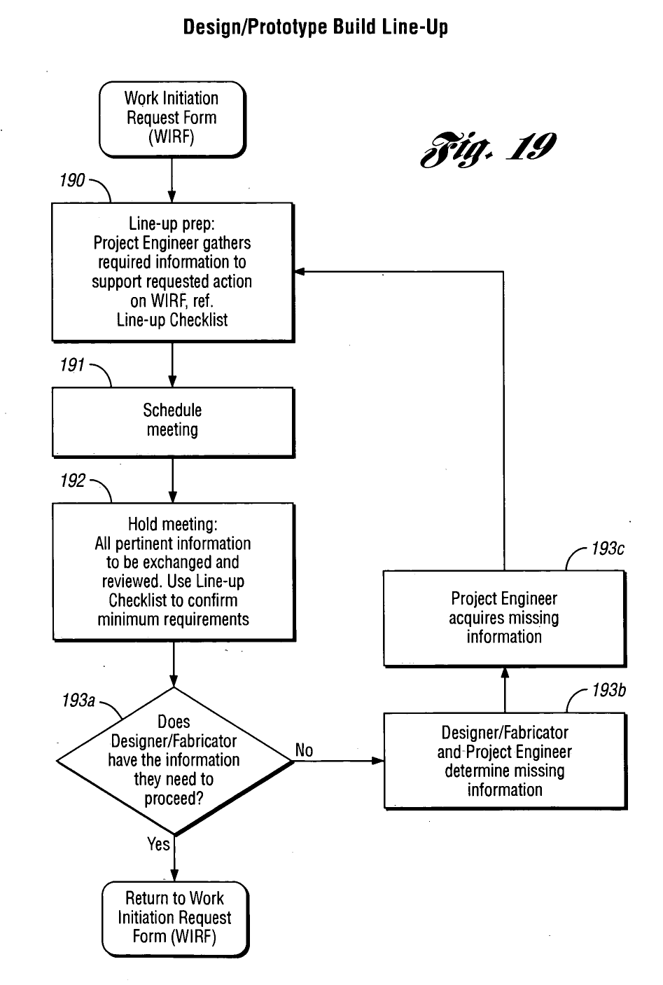

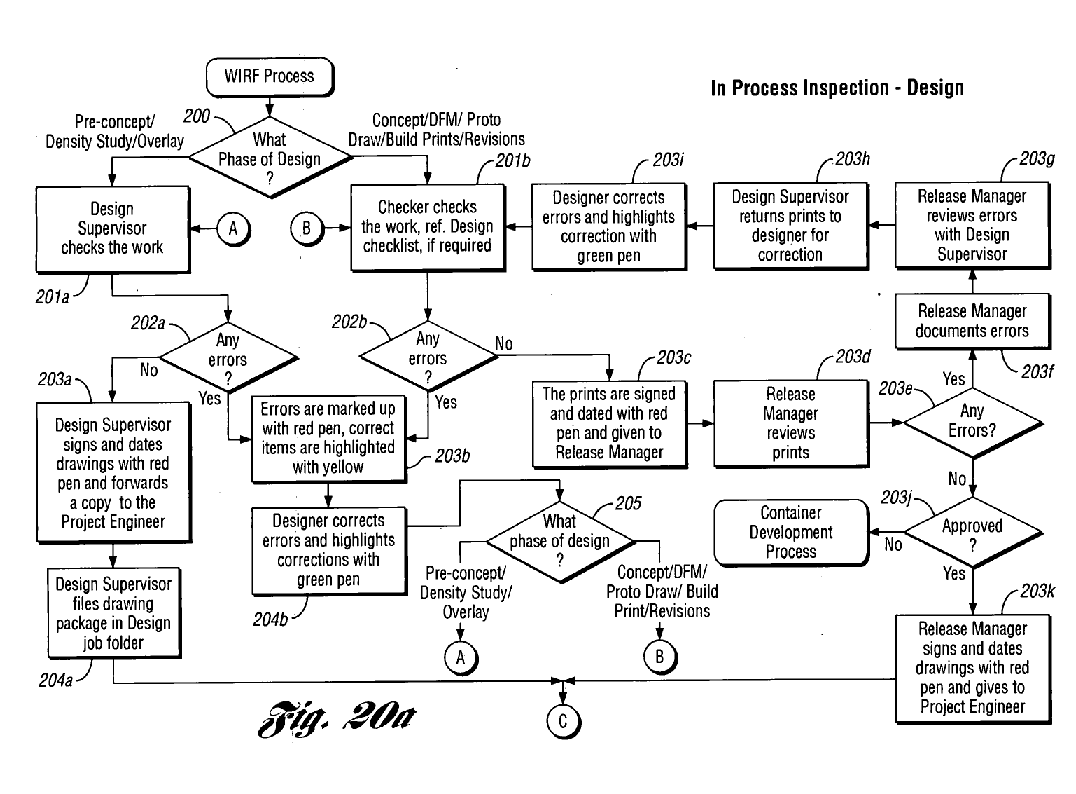

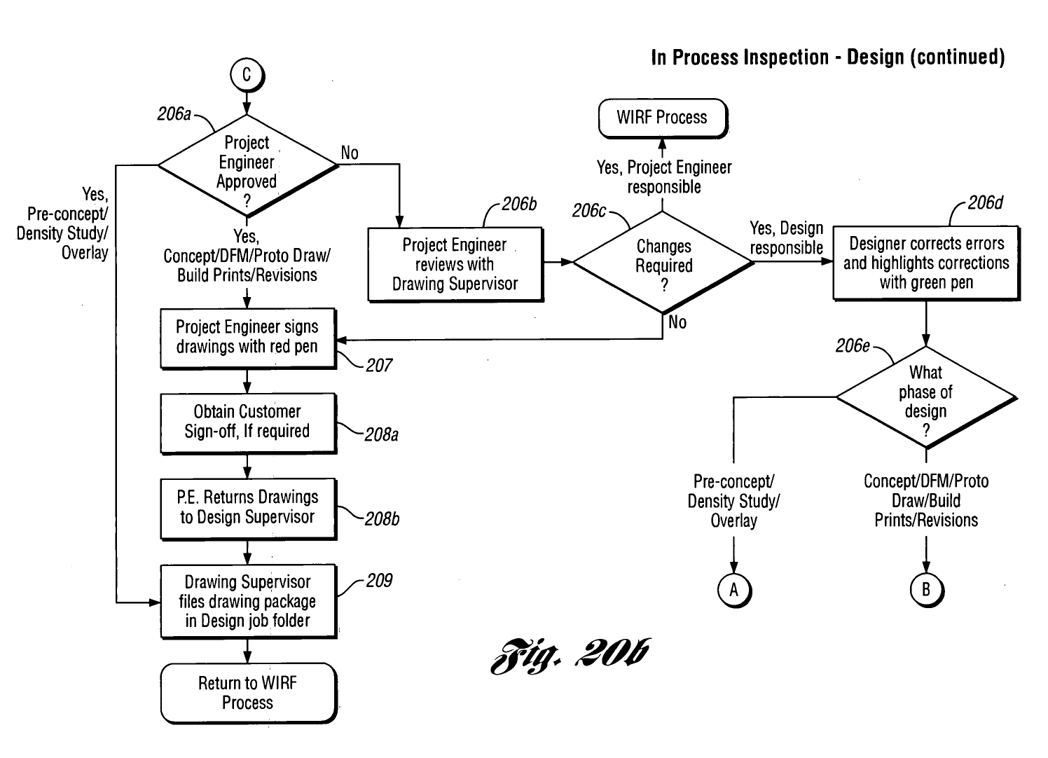

At block 169, implement the design prototype build line-up procedure of FIG. 19. At block 160′, work completed per WIRF (see FIG. 35). At block 161a′, determine if design or in-house prototype build. If in-house prototype build, at block 161b′, implement the 1^{st} article process of FIG. 28. If design, at block 161c′, implement an in-process inspection—design of FIGS. 20a and 20b.

Then, at block 162a′, determine if the purchase order is authorized. If it is, go to block 163′. If no, at block 162b′, determine if a deviation is approved. If yes, go to block 163′. If no, at block 162c′, wait for a purchase order from the customer and then return to block 162a′.

At block 163′, complete transmittal form. At block 164a′, implement a ship prototype process of FIG. 24 if a prototype is built in-house.

At block 164b′, distribute prints if a design.

At block 165′, invoice the customer for the work performed and return to the process of FIG. 2.

FIG. 17 illustrates the math data acquisition process. At block 170, ECA (i.e., engineering change analyst) pulls list of WIRFs with RFD status to start the acquisition of data. At block 171a, determine if data acquisition complete. If not, at block 171b, ECA sets to RFD2 if first attempt fails. At block 171c, re-attempt download. At block 171d, determine if the data acquisition is complete. If complete, go back to block 171a. If not, at block 171e, the ECA sets to RFD3 if the second attempt fails. At block 171f, re-attempt download.

At block 171g, determine if this is the third attempt and failure of acquisition. If no, go back to block 171a. If yes, at block 171h, the ECA places the WIRF on hold. At block 171i, the ECA notifies the project engineer. At block 171j, the engineer resolves the data availability issue.

At block 171k, the engineer changes the WIRF status to RFD and return is made to block 170.

At block 172, produce an output tree of data acquired and forward to the project engineer, including date acquired. At block 173, the ECA places data in appropriate location for either in-house design or outside design transfer. At block 174, the ECA changes the status of the WIRF to SW2 alerting the designer and the engineer that data is available to begin work or transfer to outside design source.

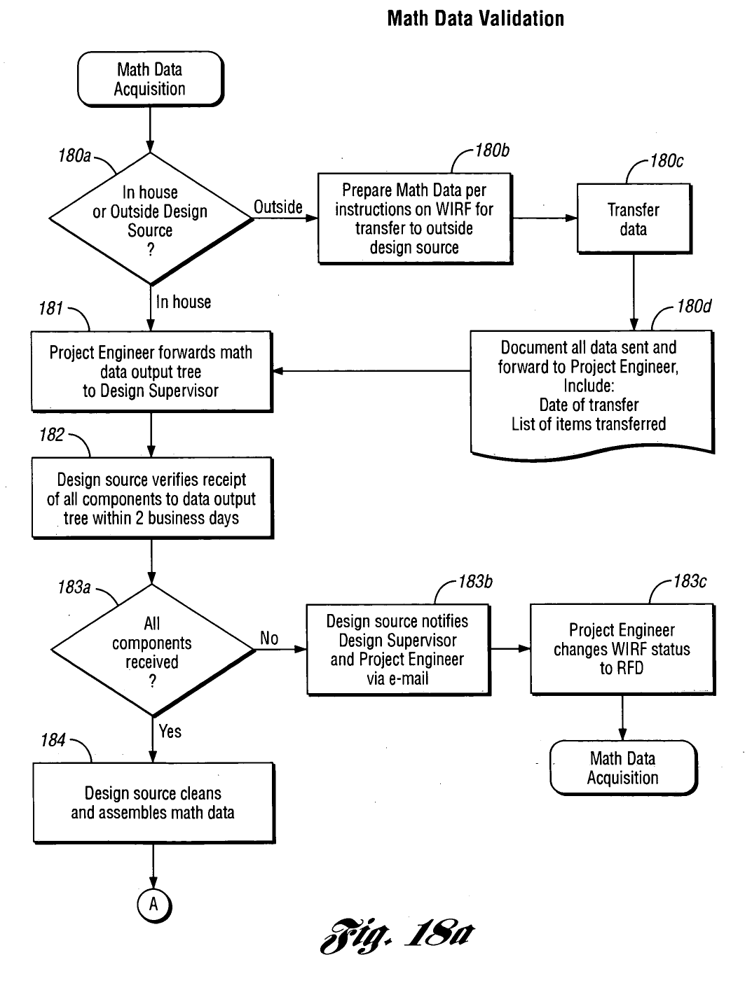

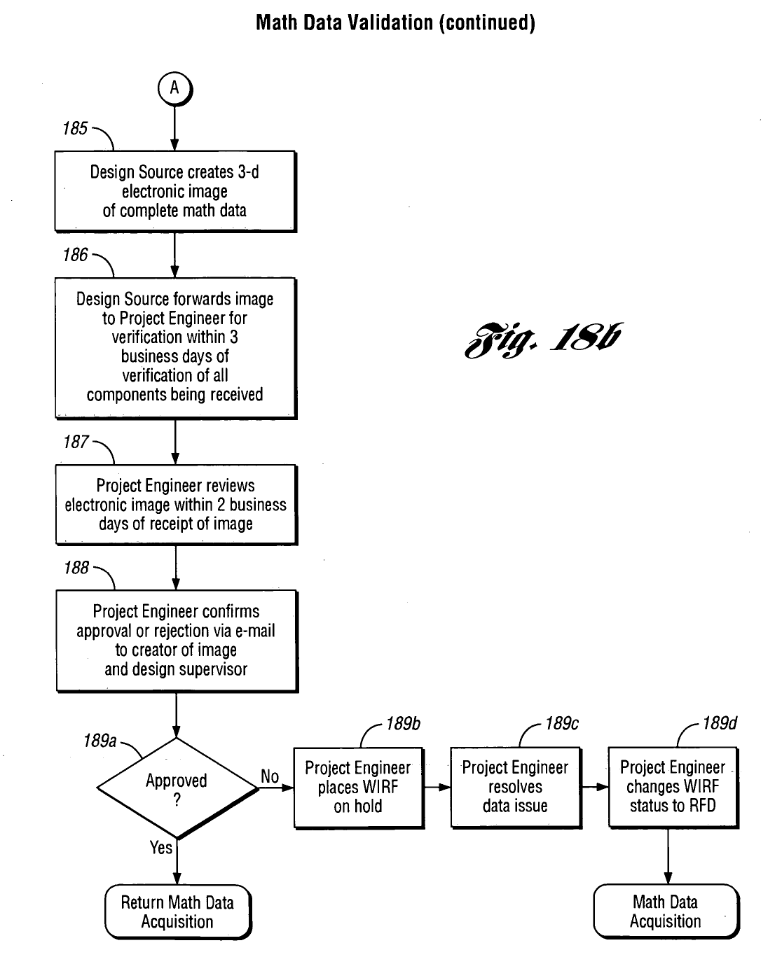

At block 175, implement the math data validation process of FIGS. 18a and 18b. Then return to the WIRF process of FIGS. 16a and 16b.

FIGS. 18a and 18b illustrate the math data validation process. At block 180a, determine if an in-house or an outside design source is to be used. If outside, at block 180b, prepare math data per instructions on the WIRF for transfer to an outside design source. At block 180c, transfer the data. At block 180d, document all data sent and forward to project engineer, including date of transfer and list of items transferred.

At block 181, the project engineer forwards math data output tree to the design supervisor. At block 182, the design source verifies receipt of all components to data output tree within two business days. At block 183a, determine if all components are received. If no, at block 183b, the design source notifies the design supervisor and the project engineer via e-mail. At block 183c, the project engineer changes the WIRF status to RFD and return is made to the process of FIG. 17.

If all components are received, at block 184, the design source cleans and assembles math data and the process enters block 185 of FIG. 18b, which further illustrates the math data validation process.

At block 185, the design source creates a 3-D electronic image of the complete math data. At block 186, the design source forwards the image to the project engineer for verification within three business days of verification of all components being received. At block 187, the project engineer reviews the electronic image within two business days of receipt of image. At block 188, project engineer confirms approval or rejection via e-mail to creator of the image and the design supervisor. At block 189a, determine if the electronic image is approved. If yes, return to the process of FIG. 17. If no, at block 189b, the project engineer places the WIRF on hold. At block 189c, the project engineer resolves the data issue. At block 189d, the project engineer changes the WIRF status to RFD and return is made to the process of FIG. 17.

FIG. 19 illustrates design/prototype build line-up process from the process of FIGS. 16a and 16b.

At block 190, line-up preparation: project engineer gathers required information to support requested action on WIRF, referencing the line-up checklist. At block 191, schedule a meeting. At block 192, hold meeting: all pertinent information to be exchanged and reviewed. Use line-up checklist to confirm minimum requirements. At block 193a, determine if the designer/fabricator have the information they need to proceed. If yes, return to the process of FIGS. 16a and 16b. If no, at block 193b, the designer/fabricator and the project engineer determine missing information. At block 193c, the project engineer acquires missing information and block 190 is re-entered.

FIG. 20a illustrates the in process inspection—design process entered from the WIRF process of FIGS. 16a and 16b. At block 200, determine what phase of design. If pre-concept/density study/overlay, at block 201a, the design supervisor checks the work. If concept/DFM/proto draw/build prints/revisions, at block 201b, the checker checks the work, referencing design checklist, if required. From block 201a, at block 202a, determine if there are any errors.

From block 201b, at block 202b, determine if there are any errors.

From block 202a, if there are no errors, at block 203a, the design supervisor signs and dates drawings with red pen and forwards a copy to the project engineer.

From either block 202a or block 202b, if there are errors, at block 203b, errors are marked up with red pen, correct items are highlighted with yellow.

From block 202b, if there are no errors, at block 203c, the prints are signed and dated with red pen and given to the release manager. At block 203d, the release manager reviews the prints. At block 203e, determine if there are any errors. If there are errors, at block 203f, the release manager documents the errors. At block 203g, the release manager reviews the errors with the design supervisor. At block 203h, the design supervisor returns the prints to the designer for correction. At block 203i, the designer corrects the errors and highlights the corrections with a green pen.

If there are no errors as determined at block 203e, at block 203j, determine if approved. If no, return to the process of FIG. 3. If yes, at block 203k, the release manager signs and dates the drawings with a red pen and gives to the project engineer and the process continues to block 206a of FIG. 20b.

At block 204a, the design supervisor files the drawing package in a design job folder and the process continues to block 206a.

At block 204b, the designer corrects the errors and highlights corrections with a green pen. At block 205, determine what phase the design is in. If in the pre-concept/density study/overlay phase, go to block 201a. If in the concept/DFM/proto draw/build prints/revisions phase, go to block 201b.

FIG. 20b further illustrates the in process inspection—design process. At block 206a, determine if project engineer approved. If not, at block 206b, the project engineer reviews with the design supervisor. At block 206c, determine if changes are required. If yes, design responsible at block 206d, the designer corrects the errors and highlights corrections with a green pen. At block 206e, determine what phase the design is in. If pre-concept/density study/overlay, go to block 201a. If concept/DFM/proto draw/build prints/revisions, go to block 201b. If yes, project engineer responsible at block 206c, go to WIRF process of FIGS. 16a-16c.

Coming from block 206a, if yes, concept/DFM/proto draw/build prints/revisions at block 207, the project engineer signs the drawings with a red pen. At block 208a, obtain customer sign-off, if required. At block 208b, the project engineer returns the drawings to the design supervisor. Coming from block 206a, if yes and the phase is pre-concept/density study/overlay phase, at block 209, the design supervisor files the drawing package in a design job folder and return is made to the WIRF process of FIGS. 16a and 16b.

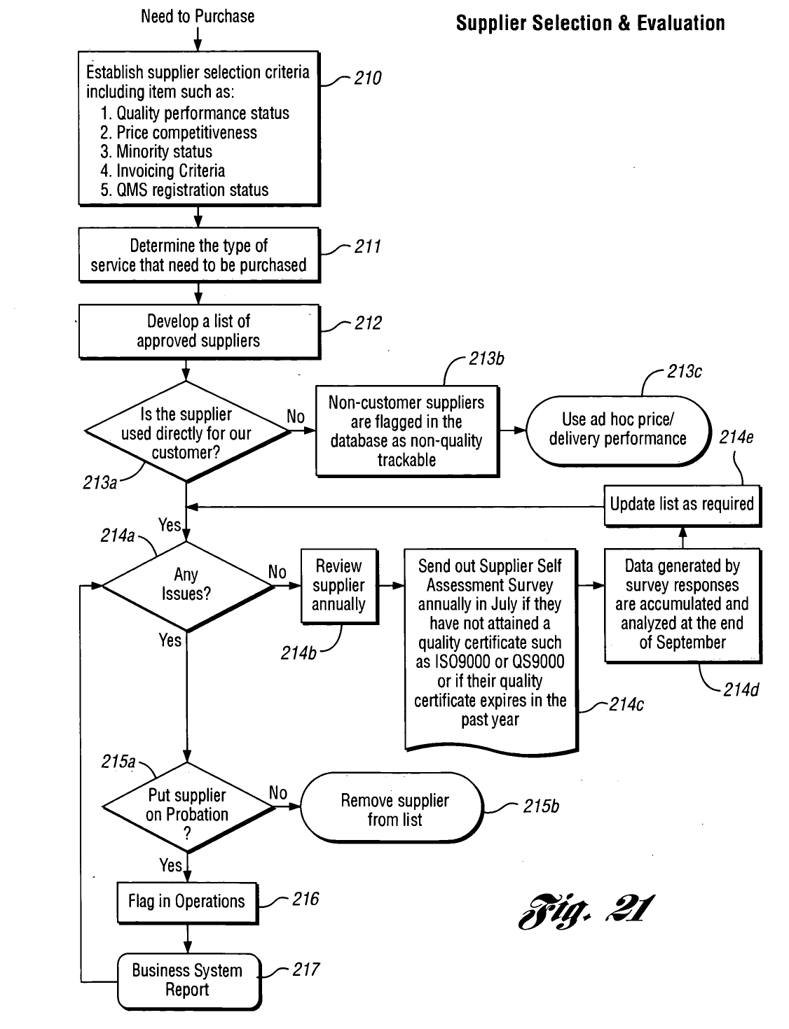

FIG. 21 illustrates a supplier selection and evaluation process. At block 210, establish supplier selection criteria, including items such as: quality performance status, pricing competitiveness, minority status, invoicing criteria, and QMS registration status. At block 211, determine the type of services that need to be purchased. At block 212, develop a list of approved suppliers. At block 213a, determine if the supplier is used directly for our customers. If no, at block 213b, non-customer suppliers are flagged in the database as non-quality trackable. At block 213c, use ad hoc price/delivery performance.

If yes, at block 214a, determine if there are any issues. If no, at block 214b, review supplier annually. At block 214c, send out supplier self assessment survey annually in July if they have not attained a quality certificate such as ISO9000 or QS9000 or if their quality certificate expires in the past year. At block 214d, data generated by survey responses are accumulated and analyzed at the end of September. At block 214e, update list as required and return to block 214a.

If there are issues, coming from block 214a, at block 215a, determine whether to put supplier on probation. If no, at block 215b, remove supplier from list. If yes, at block 216, flag in operations. At block 217, go to a business system report process. Then go back to block 214a.

FIG. 22a illustrates the purchasing process after a need to purchase has been identified.

At block 220, the requisitioner receives quote(s), or gathers blanket order information. At block 221, the requisitioner fills out on-line requisition form in operations database (i.e., FIGS. 39 and 40).

At block 222, submit requisition and quote/blanket order information to analyst for approval. At block 223, analyst reviews, prepares, and approves, referencing checklist. This is documented with a signature on the purchase requisition form. At block 224a, determine if requisition is approved. If no, at block 224b, determine if changes are required. If yes, at block 224c, requisition incorrectly prepared (RIP) form is filled out and returned to the requisitioner for correction or clarification. At block 224d, the requisitioner is notified of the rejection and block 221 is re-entered.

If changes are not required from block 224b, at block 224e, cancel the requisition and at block 224f notify the requisitioner of the cancellation.

If the purchase requisition is approved at block 224a, at block 225, the purchase order requisition is reviewed by management, as necessary, referencing checklist. At block 226, determine if approved. If not, go to block 224b.

If approved, at block 227, accounts payable generates purchase order through integrated accounting package with copy forwarded to the requisitioner and faxed to vendor. The block 228 of FIG. 22b is entered, which further illustrates the purchasing process.

At block 228, documentation confirming the transmission is maintained by accounts payable. At block 229, the vendor invoice arrives. At block 220′, accounts payable enters invoice information into the invoice log. At block 221′, the invoice is forwarded to the requisitioner for approval. At block 222a′, determine if approved. If not, at block 222b′, requisitioner resolves discrepancy and return to block 221′.

If yes, at block 223′, the invoice is forwarded to the analyst for approval, if required. At block 224a′, determine if approved. If not, at block 224b′, the analyst contacts the requisitioner for resolution and return to block 223′. If yes, at block 225′, the invoice is forwarded to the controller for approval, if required. At block 226a′, determine if approved. If not, at block 226b′, the controller contacts the requisitioner for resolution and return to block 225′.

If yes, at block 227′, the controller forwards the invoice to accounts payable for entry into the integrated accounting package. At block 228′, update invoice log with approved/received back date.

At block 229′, accounts payable records purchase order quantity received through integrated accounting package. At block 220″, accounts payable pays the invoice.

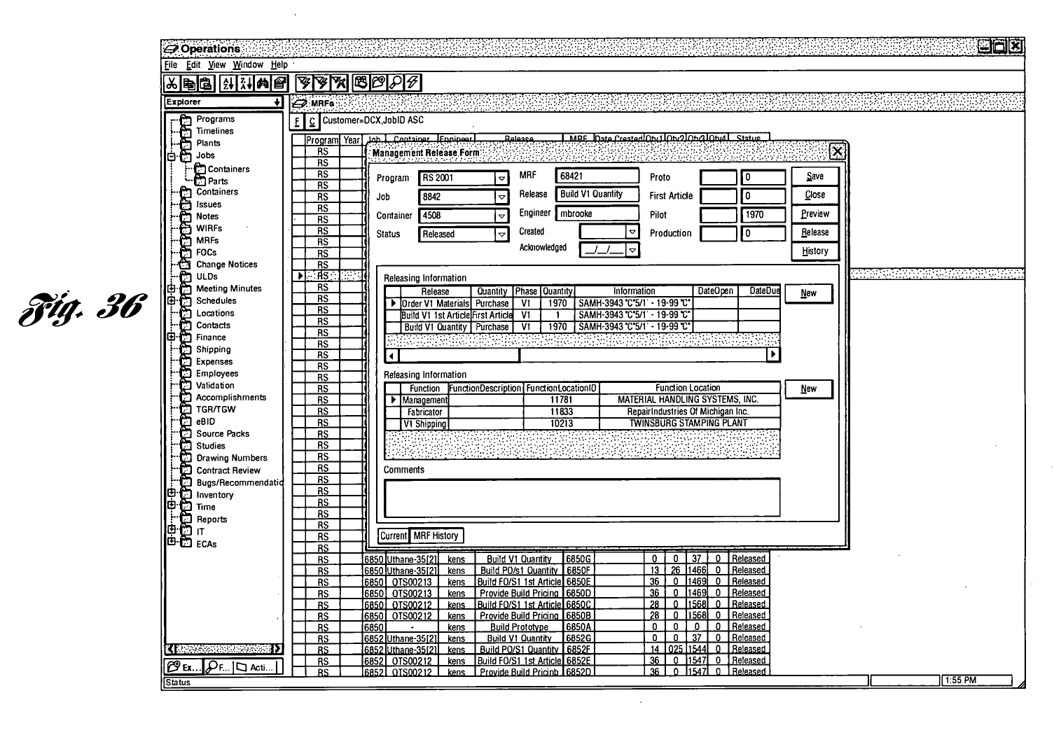

FIG. 23 illustrates the management release form (MRF) process after it has been determined that a supplier is required to take action. At block 230, the project engineer or designee fills out the MRF per on-line information in the database (i.e., FIG. 36). At block 231a, determine if customer approval required. If no, at block 231b, document why customer approval is not required and go to block 235. If yes, at block 232, the MRF is submitted to the customer for authorization. At block 233a, determine if customer approved. If no, at block 233b, determine if the MRF revision is requested. If yes, go to block 230. If no, at block 233c, the MRF is rejected, cancelled and closed.

If the customer approved the MRF, at block 234, the customer signs the MRF and returns it. At block 235, the project engineer or designee forwards the signed MRF to the supplier. At block 236, the supplier fills in the MRF, signs and returns the MRF confirming action to be taken. At block 237, the project engineer or designee updates the system and the database with a date that the fabricator acknowledges.

At block 238, the project engineer or designee files signed MRF in a project file.

FIGS. 24a and 24b illustrate a shipping process for shipping product and/or materials via a commercial carrier after a need to ship has been identified.

At block 240, a requestor fills out shipping request form in the database and forwards it to a shipping clerk. At block 241a, determine if funds are available. If no, at block 241b, acquire funds and return to block 241a. If yes, at block 242, review the shipping request form for accuracy. At block 243, verify ship date. At block 244a, determine if the request is accurate. If not, at block 244b, contact requestor for any other information needed and return to block 242. If accurate, at block 245, determine and contact shipping company. At block 246a, determine if internal or external shipment. If external, at block 246b, process assigned to external carrier. At block 246c, file the paperwork.

If internal, at block 247, fill out bill of lading. At block 248a, determine if customs paperwork required. If yes, at block 248b, complete customs paperwork.

After block 248b and if paperwork is not requited, at block 249, the shipping clerk inputs carrier name and bill of lading number onto shipping request form in the database. At block 240′, determine packaging requirements and package as required. At block 241′, stage item for shipping. At block 242a′, determine if truck has arrived. If no, at block 242b′, hold item in staging area and return to block 242a′.

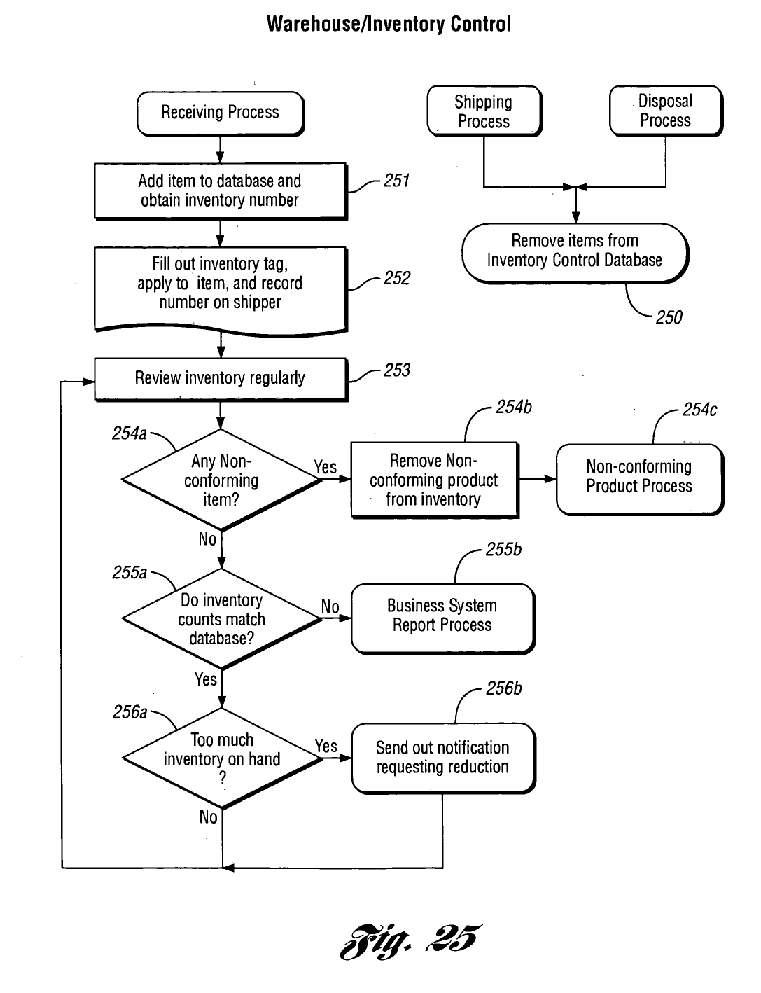

If the truck has arrived, at block 243′, load the truck. At block 244′, shipping company signs bill of lading. At block 245′, the shipping clerk or designee signs carrier's paperwork, if required. At block 246′, file the paperwork and go to the inventory control process of FIG. 25.

FIG. 25 illustrates a warehouse/inventory control process. At block 250, and coming from either the shipping process of FIG. 24 or a disposal process, remove items from inventory control database.

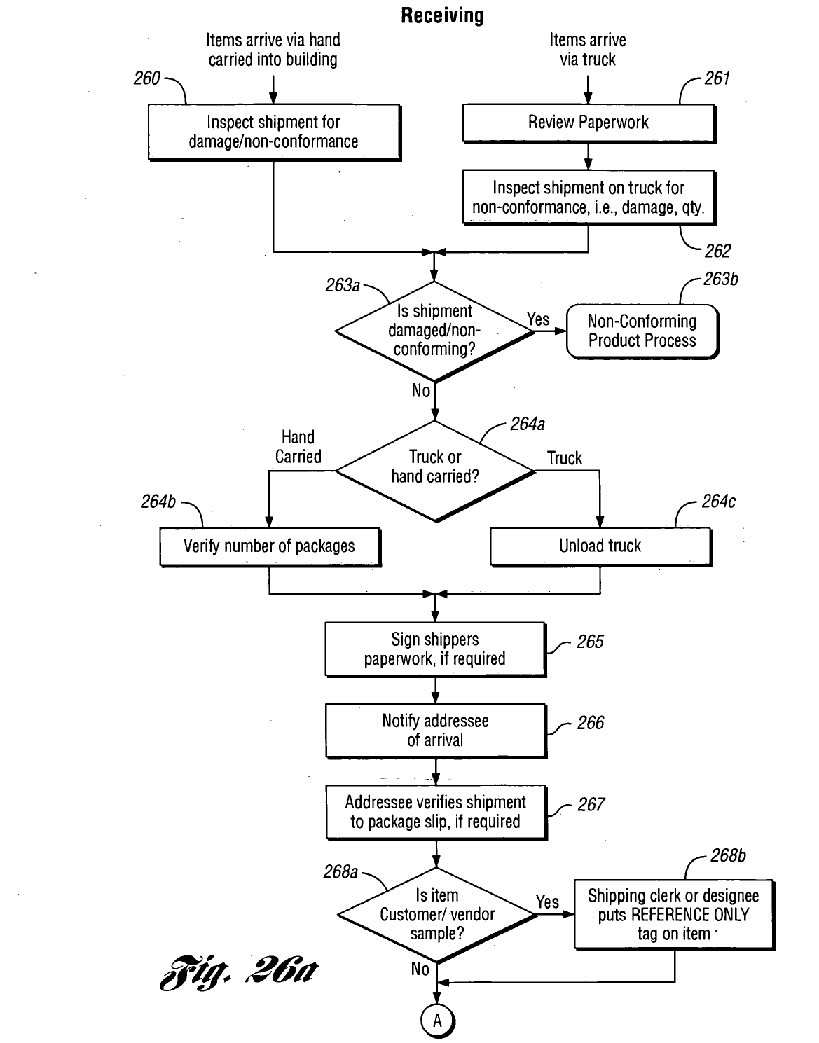

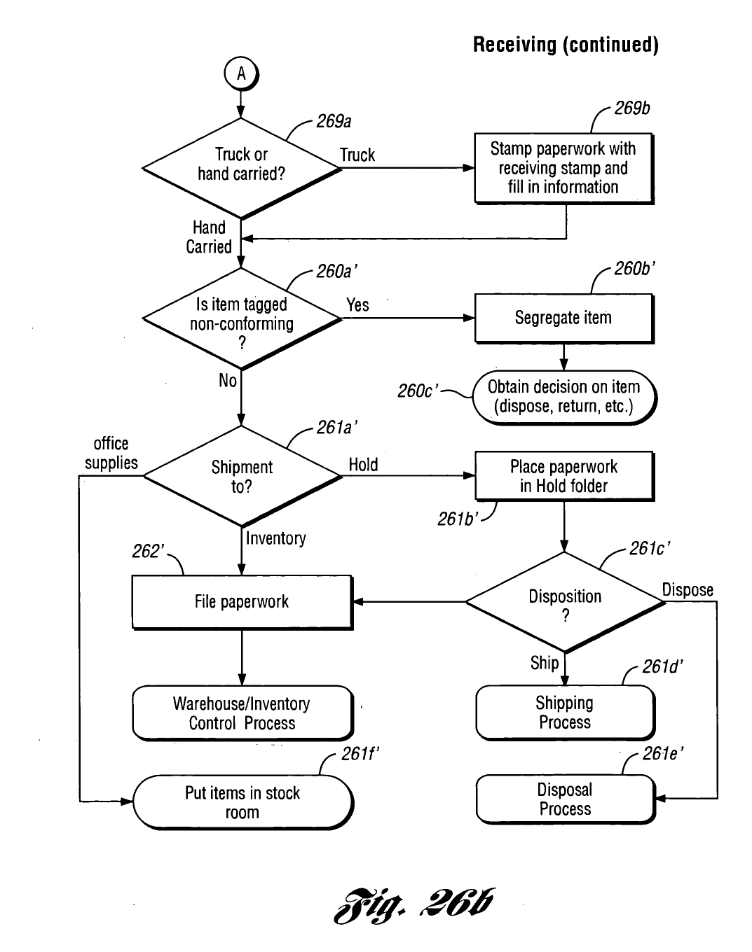

Coming from a receiving process of FIGS. 26a and 26b, at block 251, add item to the database and obtain inventory number. At block 252, fill out inventory tag, apply to item, and record number on shipper. At block 253, review inventory regularly. At block 254a, determine if there are any non-conforming items. If yes, at block 254b, remove non-conforming product from inventory.

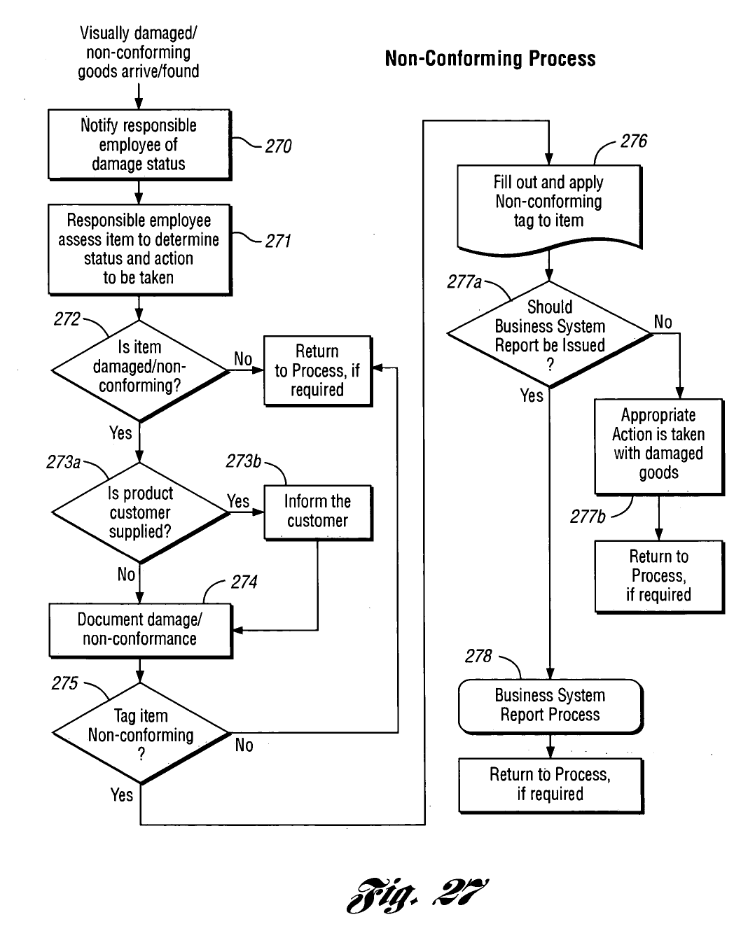

At block 254c, implement non-conforming product process of FIG. 27.

If no and coming from block 254a, at block 255a, determine if inventory counts match database counts. If no, at block 255b, implement a business system report process. If yes, at block 256a, determine if too much inventory is on hand. If yes, at block 256b, send out notification requesting reduction. If no, return to block 253.

FIGS. 26a and 26b illustrate a receiving process to receive, inspect, identify and control product or material prior to transferring to the warehouse process of FIG. 25 or engineering.

At block 260, inspect a hand-carried shipment for damage/non-conformance. At block 261, review paperwork of an item which has arrived via truck. At block 262, inspect shipment on truck for non-conformance, i.e., damage, qty. At block 263a, determine if shipment is damaged/non-conforming. If yes, at block 263b, implement non-conforming product process of FIG. 27. At block 264a, determine if truck or hand-carried item. If hand-carried, at block 264b, verify number of packages. If truck, at block 264c, unload the truck. At block 265, sign shipper's paperwork, if required. At block 266, notify addressee of arrival.

At block 267, addressee verifies shipment to packaging slip, if required. At block 268a, determine if item is customer/vendor sample. If yes, at block 268b, shipping clerk or designee puts “reference only” tag on item. If no, at block 269a, determine if truck or hand carried. If truck, at block 269b, stamp paperwork with receiving stamp and fill in information. If hand-carried, at block 260a′, determine if item tagged is non-conforming. If yes, at block 260b′, segregate item. At block 260c′, obtain decision on item (dispose, return, etc.). If no, at block 261a′, determine where to house shipment. If hold, at block 261b′, place paperwork in hold folder. At block 261c′, determine disposition. If dispose, go directly to block 261e′. If ship, at block 261d′, implement shipping process of FIG. 24.

At block 261e′, implement disposal process.

At block 261f′, put items in stock room if office supplies.

At block 262′, file paperwork if inventory and go to the process of FIG. 25.

FIG. 27 illustrates a non-conforming product process to receive, inspect, identify and control product and material prior to transferring to the warehouse process of FIG. 25 or engineering.

At block 270, notify responsible employee of damage status after visually damaged/non-conforming goods arrive or are found.

At block 271, responsible employee assess item to determine status and action to be taken. At block 272, determine if item is damaged/non-conforming. If no, return to process if required. If yes, at block 273a, determine if product is customer supplied. If yes, at block 273b, inform the customer and to go to block 274 to document damage/non-conformance. If product is not customer-supplied, go to block 274.

At block 275, determine whether to tag item non-conforming. If no, return to process if required. If yes, at block 276, fill out and apply non-conforming tag to item.

At block 277a, determine if business system report should be issued. If no, at block 277b, appropriate action is taken with damaged item and return to process if required. If yes, at block 278, implement business system report process and return to process if required.

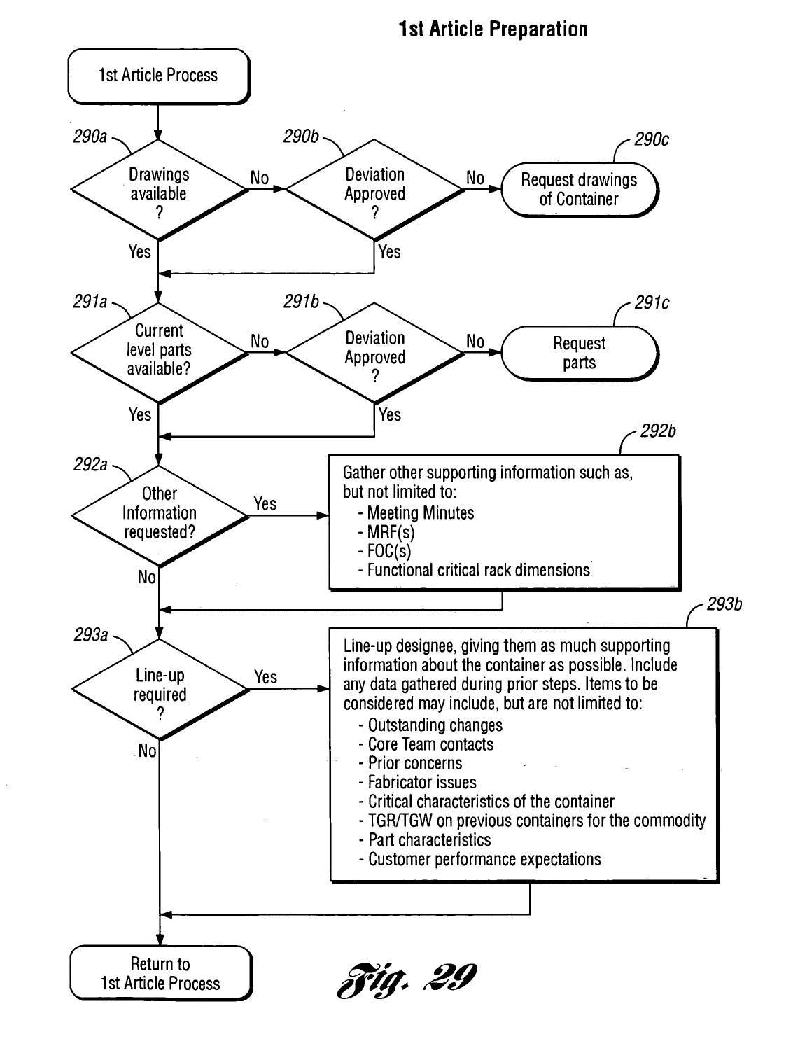

FIG. 28 illustrates the 1^{st} article (pre-production) process after the supplier has informed the user that the container is ready for 1^{st} article inspection. At block 280, 1^{st} article preparation process of FIG. 29 starts.

At block 281, schedule 1^{st} article inspection.

At block 282, sign out/obtain 1^{st} article measurement equipment, as required.

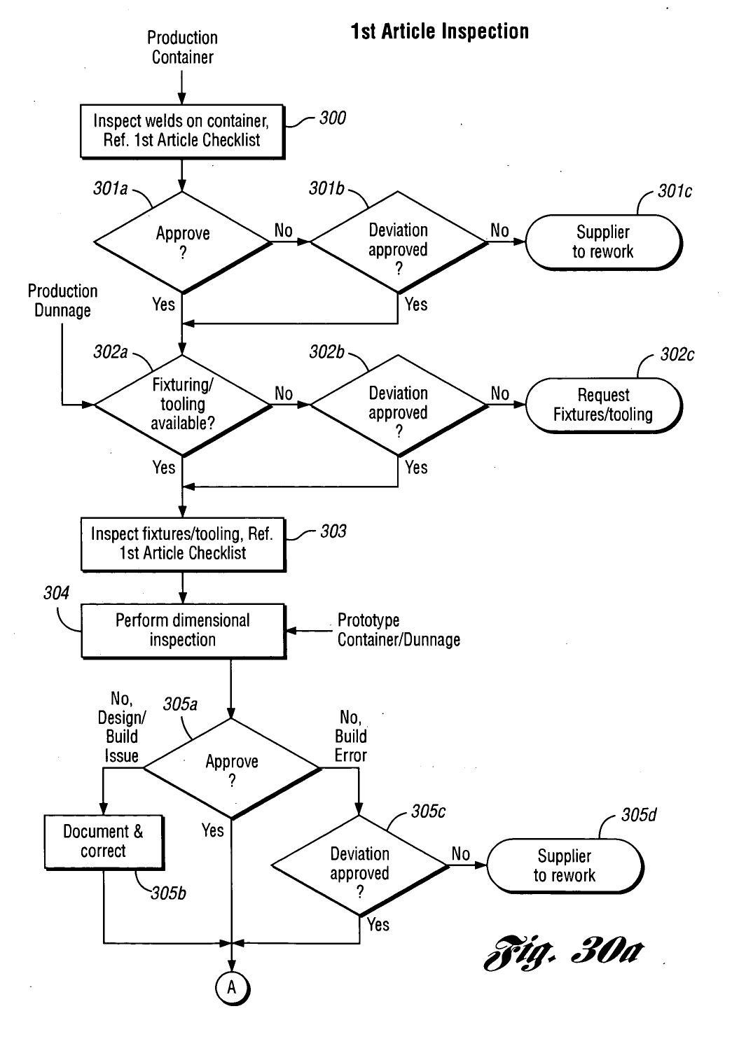

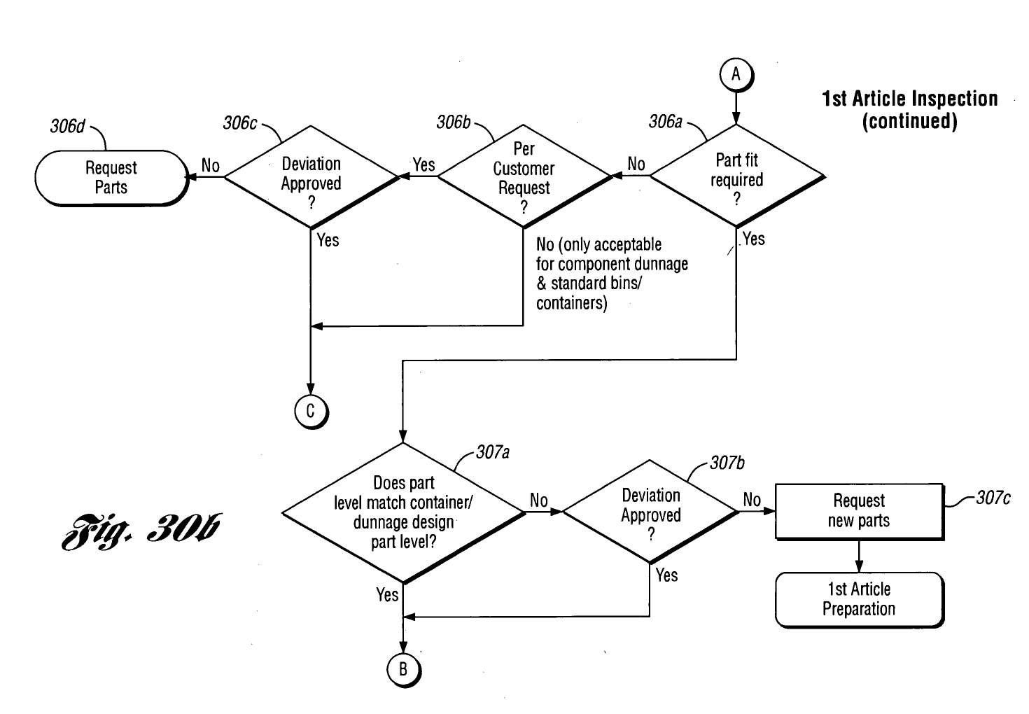

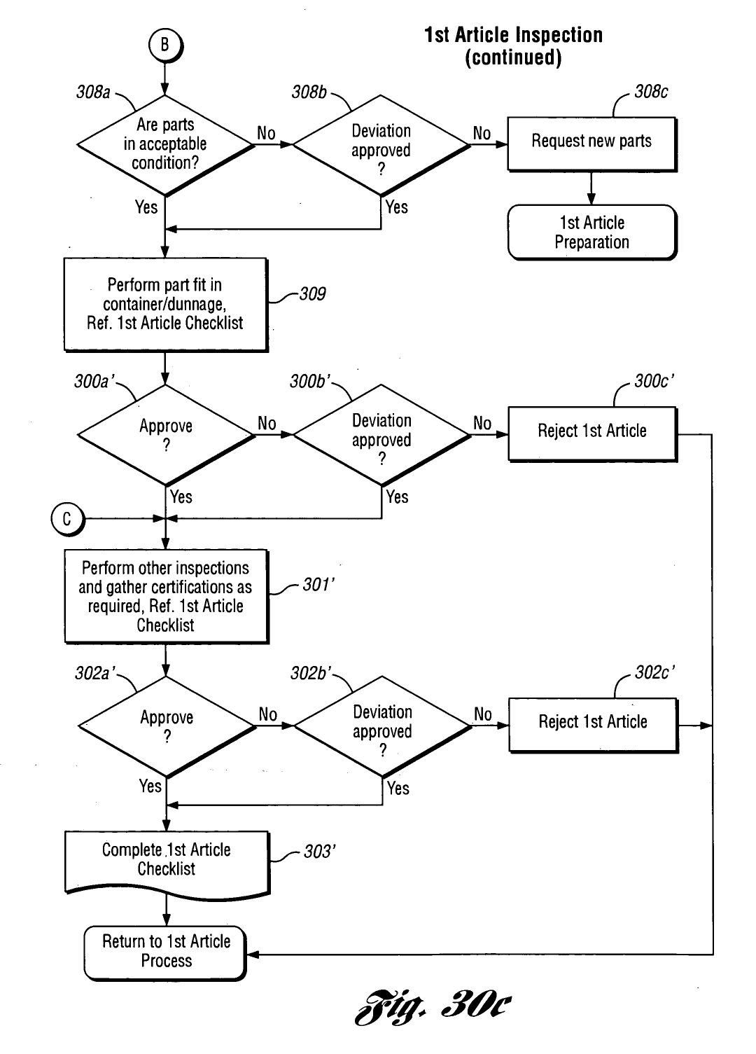

At block 283, perform 1^{st} article inspection of FIGS. 30a and 30b.

At block 284a, determine if product is approved. If no, at block 284b, rework product. If yes, at block 285, file 1^{st} article paperwork in job file and return to the main process.

FIG. 29 illustrates the 1^{st} article preparation process entered from the process of FIG. 28.

At block 290a, determine if drawings are available. If not, at block 290b, determine if a deviation is approved. If not, at block 290c, request drawings of containers. If yes, at block 291a, determine if current level parts are available. If not, at block 291b, determine if a deviation is approved. If not, at block 291c, request parts. If deviation is approved, at block 292a, determine if other information is required. If required, at block 292b, gather other supporting information such as, but not limited to, meeting minutes, MRF(s), FOC(s), and functional critical rack dimensions from the database. If no other information is required, at block 293a, determine if line-up is required. If required, at block 293b, line-up designee, giving them as much supporting information about the container as possible. Include any data gathered during prior steps. Items to be considered may include, but are not limited to, outstanding changes, core team contacts, prior concerns, fabricator issues, critical characteristics of the container, experience on previous containers for the commodity, part characteristics, and customer performance expectations. If line-up is not required, return to the process of FIG. 28.

FIGS. 30a, 30b and 30c illustrate a 1^{st} article inspection process after a production container has been obtained. At block 300, inspect welds on container, reference 1^{st} article checklist. At block 301a, determine if approved. If not, at block 301b, determine if a deviation is approved. If no, at block 301c, the supplier is to rework the container. If a deviation is approved, at block 302a, determine if fixtures/tooling are available.

If dunnage is inspected, this is the first block in that process. If not available, at block 302b, determine if a deviation is approved.

If not, at block 302c, request fixtures/tooling. If approved, at block 303, inspect fixtures/tooling, reference 1^{st} article checklist. At block 304, perform dimensional inspection. If prototype container/dunnage is inspected, this is the first block in that process. At block 305a, determine if approved. If not approved and it's a design/build issue, at block 305b, document and correct. If not approved and it's a build error, at block 305c, determine if a deviation is approved. If not, at block 305d, the supplier is to rework.

FIGS. 30b and 30c further illustrate the 1^{st} article inspection process. If approved, at block 306a, determine if part fit is required. If no, at block 306b, determine if per customer request. If yes, at block 306c, determine if deviation approved. If no, at block 306d, request parts. If approved, go to block 301′ of FIG. 30b. Also, go to block 301′ if its not per the customer request.

If part fit is required, at block 307a, determine if part level matches container/dunnage design part level. If yes, go to block 308a of FIG. 30c. If no, at block 307b, determine if a deviation is approved. If yes, go to block 308a. If no, at block 307c, request new parts and return to the process of FIG. 29.

At block 308a, determine if the parts are in an acceptable condition. If no, at block 308b, determine if a deviation is approved. If no, at block 308c, request new parts and return to the process of FIG. 29.

If yes, at block 309, perform part fit in container/dunnage, reference 1^{st} article checklist. At block 300a′, determine if approved. If not, at block 300b′, determine if a deviation is approved. If no, at block 300c′, reject the 1^{st} article and return to the process of FIG. 28.

If a deviation is approved, at block 301′, perform other inspections and gather certifications as required, referencing 1^{st} article checklist. At block 302a′, determine if approved. If no, at block 302b′, determine if a deviation is approved. If no, at block 302c′, reject the 1^{st} article and return to the process of FIG. 28.

If a deviation is approved, at block 303′, complete the 1^{st} article checklist and return to the process of FIG. 28.

FIG. 31 illustrates a prototype review process reached from the process of block 310 (FIG. 4).

At block 311a, determine if parts available. If no, at block 311b, determine if a deviation is approved. If no, at block 311c, acquire parts and return to block 311a. If yes, at block 312, schedule proto review meeting, including project engineer, OEM supplier representative, assembly plant representative, in-house customer representative, and others, as required. At block 313, conduct prototype container/dunnage review. At block 314a, determine whether to approve prototype. If no, at block 314b, document meeting results and distribute meeting minutes (see database meeting minutes). At block 314c, determine if changes are required.

If no, at block 314d, implement container development process of FIG. 3.

If yes, at block 314e, implement field order change process of FIG. 33. At block 314f , implement WIRF process of FIGS. 16a and 16b, if required (design changes and/or in-house prototype changes). At block 314g, determine whether to review prototype changes. If yes, go to block 311a. If no, return to process of FIG. 4.

At block 315 and coming from block 314a, document meeting results and distribute meeting minutes (also database).

FIG. 32 illustrates release for production process coming from the initiate/manage build process 320 (i.e., FIGS. 6a and 6b).

At block 321, the project engineer obtains all changes from previous print level, supporting documents, open FOCs and any other information, as required. At block 322, implement the WIRF process of FIGS. 16a and 16b. At block 323, obtain customer sign-off, if required and at block 324, return to the initiate/manage build process of FIGS. 6a and 6b.

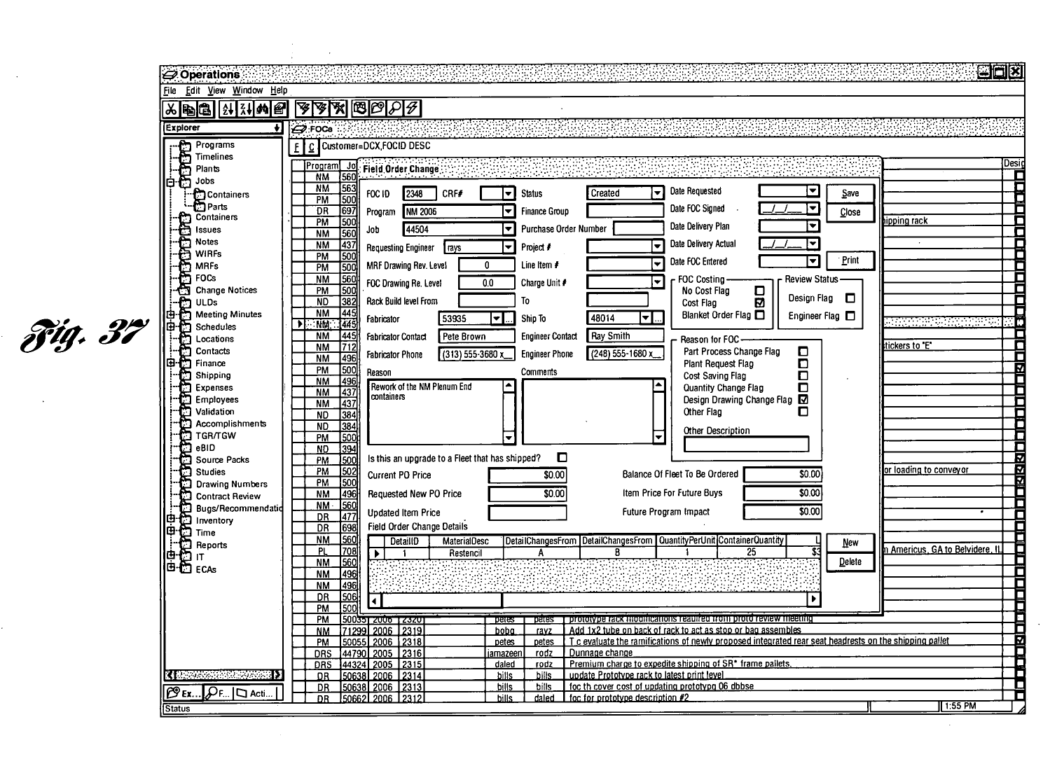

FIGS. 33a and 33b illustrate a field order change (FOC) process after a field change has been identified. At block 330, fill out FOC form per on-line information (see FIG. 37). At block 331a, FOC is identified as either “cost” or “no cost.” If “cost,” at block 331b, quote is requested from supplier.

At block 331c, supplier returns quote. At block 331d, the FOC is updated with cost information. At block 331e, verify funds are available. At block 332, the FOC form is submitted to customer for authorization. At block 333, determine if customer approval required. If no, go to block 336. If yes, at block 334a, determine is customer approved. If no, at block 334b, determine if FOC revisions are requested. If yes, at block 334c, return to author. If no, at block 334d, the FOC is rejected, cancelled and closed.

Coming from block 334a, if yes, at block 335, the customer signs and returns the FOC form to the author. At block 336, the FOC is implemented. At this point, entry into the process from the process of FIGS. 6a and 6b is possible.

At block 337a, determine if it's a cost FOC. If yes, at block 337b, determine if in-house or customer purchased item. If customer, at block 337c, go to appropriate customer pre-requisition process. If in-house, at block 337d, go to the process of FIGS. 22a and 22b.

Coming from block 337a, if no, at block 338, determine if WIRF is required. If no, go to block 330′.

If yes, at block 339, implement WIRF process of FIGS. 16a and 16b. At block 330′, the project engineer updates appropriate flags in system (i.e., database).

At block 331′, the project engineer files the signed FOC form and supporting documentation in project file and return to the process, if required.

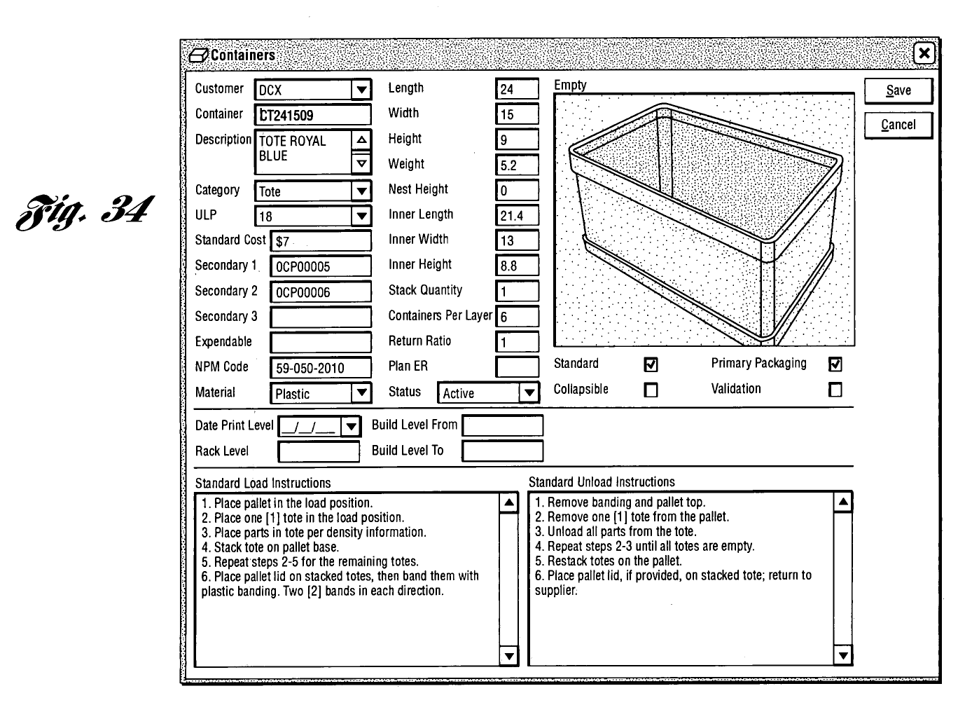

FIG. 34 is a screen shot of an electronic container form which is filled out with data which describes a container, an image of which is also shown. Instructions for loading and unloading the container are also provided on the form. The container form is located in the relational database in the computer 12.

FIG. 35 is a screen shot of a pair of windows, one of which lists a number of WIRFs (i.e., work initiation request forms) and the overlying window illustrating a particular, filled-out WIRF. The form is also located in the relational database.

FIG. 36 is a screen shot of a pair of windows, one of which lists a number of MRFs (i.e., management release forms) and the overlying window illustrating a particular, filled-out MRF. As with the other forms, the MRFs are also located in the database in the computer 12.

FIG. 37 is a screen shot of a pair of windows, one of which lists a number of field order changes (i.e., FOCs) and the overlying window illustrating a particular field order change form located within the database.

FIG. 38 is a screen shot of a pair of windows, one of which lists a number of meeting minutes and the overlying window illustrates a form filled-out with minutes from a particular meeting.

FIG. 39 is a screen shot of a pair of windows, one of which lists a number of in-house requisitions and the overlying window illustrates a form filled-out with information which facilitates the purchase of a particular item.

FIG. 40 is a screen shot, similar to the screen shot of FIG. 39, but which illustrates customer purchase requisition information.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A computer-aided method for managing a part shipping apparatus development project including a plurality of predetermined processes or procedures, the method comprising:
receiving information about the part;
storing a first set of data which identifies the part in at least one database;
filling out a first electronic work initiation request form including a plurality of fields and stored in the at least one database wherein one of the fields specifies work to be performed with respect to apparatus for shipping the part;
storing a second set of data which identifies the apparatus in the at least one database; and
creating production materials which allow the building of production apparatus for shipping the part based on the second set of data.

2. The method as claimed in claim 1, wherein the project includes a build process or procedure and wherein the method further comprises filling out an electronic release form stored in the at least one database to release a builder to perform at least one build function during the build process or procedure.

3. The method as claimed in claim 2, wherein a first article container is to be built during the build process or procedure and wherein the method further comprises inspecting the first article container and recording results of the inspection.

4. The method as claimed in claim 2, further comprising filling out a field order change form stored in the at least one database to identify, approve and implement a field order change to the apparatus.

5. The method as claimed in claim 4, further comprising filling out a second electronic work initiation request form including a plurality of fields stored in the at least one database wherein one of the fields specifies the field order change.

6. The method as claimed in claim 1, wherein the work to be performed is apparatus design work and wherein the form is a design form for requesting work to design the apparatus.

7. The method as claimed in claim 1, wherein the work to be performed is apparatus build work and wherein the form is a build form for requesting work to build the apparatus.

8. The method as claimed in claim 1, wherein one of the fields of the form specifies a deviation from one of the predetermined processes or procedures.

9. The method as claimed in claim 1, wherein one of the fields of the form specifies status of the form.

10. The method as claimed in claim 2, wherein the at least one build function includes building a prototype of the apparatus and Wherein the method further comprises reviewing the prototype and recording results of the review in the at least one database.

11. The method as claimed in claim 1, wherein the step of receiving includes the step of receiving math data which represents the part.

12. The method as claimed in claim 1, wherein the apparatus includes a rack.

13. The method as claimed in claim 12, wherein a plurality of parts are to be shipped and wherein the second set of data identifies orientation of the parts in the rack.

14. The method as claimed in claim 1, wherein the apparatus includes dunnage.

15. The method as claimed in claim 1, wherein the apparatus includes a standard container.

16. The method as claimed in claim 1, wherein the apparatus includes an expendable container.

17. The method as claimed in claim 1, further comprising modifying the second set of data to obtain a revised second set of data which identifies the apparatus and wherein the step of creating production materials is based on the revised second set of data.

18. The method as claimed in claim 1, wherein a plurality of parts are to be shipped and wherein the second set of data identifies density of the parts to be shipped with the apparatus.

19. The method as claimed in claim 1, wherein the second set of data identifies a supplier to supply the apparatus.

20. The method as claimed in claim 1, wherein the part is a vehicle part.

21. The method as claimed in claim 1, wherein the at least one data base includes a relational database.

22. The method as claimed in claim 1, wherein the second set of data also identifies a transportation mode for the container.

23. The method as claimed in claim 1, wherein the second set of data also identifies part load and unload information with respect to the apparatus.

24. The method as claimed in claim 1, wherein the project includes a container development process or procedure and wherein the method further comprises conducting at least one pre-concept phase activity and recording the results of the at least one pre-concept phase activity in the at least one database.

25. The method as claimed in claim 12, wherein the project includes a rack development process or procedure and wherein the method further comprises conducting at least one concept phase activity and recording the results of the at least one concept phase activity in the at least one database.

26. The method as claimed in claim 12, wherein the project includes a rack development process or procedure and wherein the method further comprises conducting at least one design for manufacture activity and recording the results of the at least one design for manufacture activity in the at least one database.

27. The method as claimed in claim 12, wherein the project includes a rack development process or procedure and wherein the method further comprises conducting at least one prototype draw activity and recording the results of the at least one prototype draw activity in the at least one database.

28. The method as claimed in claim 2, wherein the method further comprises monitoring the build process or procedure and collecting and recording information on any changes to be made to the apparatus during the build process or procedure in the at least one database.

29. The method as claimed in claim 1, further comprising filling out an electronic requisition form including a plurality of fields and stored in the at least one database to conduct purchasing activities.

30. The method as claimed in claim 1, further comprising filling out an electronic shipping request form including a plurality of fields and stored in the at least one database to ship product or materials.

31. The method as claimed in claim 12, wherein the project includes a rack development process or procedure and wherein the method further comprises conducting at least one density study activity and recording the results of the at least one density study activity in the at least one database.

32. A computer-aided method for managing a part shipping apparatus development project including a plurality of predetermined processes or procedures, including apparatus design work and apparatus build work, the method comprising:
receiving information about the part;
storing a first set of data which identifies the part in at least one database;
filling out a plurality of electronic forms including:
at least one electronic design form including a plurality of fields and stored in the at least one database wherein one of the fields specifies apparatus design work to be performed with respect to apparatus for shipping the part; and
an electronic release form stored in the at least one database to release a builder to perform at least one build function during a build process or procedure;
storing a second set of data which identifies the apparatus in the at least one database; and
creating production materials which allow the building of production apparatus for shipping the part based on the second set of data.
